(19) United States
(12) Patent Application Publication
(10) Pub. No.: US 2023/0102175 A1
(43) Pub. Date: Mar. 30, 2023

(54) TONER FOR DEVELOPING ELECTROSTATIC CHARGE IMAGE, ELECTROSTATIC CHARGE IMAGE DEVELOPER, TONER CARTRIDGE, PROCESS CARTRIDGE, AND IMAGE FORMING APPARATUS

(71) Applicant: FUJIFILM Business Innovation Corp., Tokyo (JP)

(72) Inventors: Ryo OTAKE, Kanagawa (JP); Sakon TAKAHASHI, Kanagawa (JP); Yosuke TSURUMI, Kanagawa (JP); Moegi IGUCHI, Kanagawa (JP); Yasuaki HASHIMOTO, Kanagawa (JP)

(73) Assignee: FUJIFILM Business Innovation Corp., Tokyo (JP)

(21) Appl. No.: 17/592,117

(22) Filed: Feb. 3, 2022

(30) Foreign Application Priority Data
Sep. 24, 2021 (JP) 2021-156192

(51) Int. Cl. G03G 9/097; G03G 9/08; G03G 15/08

(52) U.S. Cl. CPC G03G 9/09725; G03G 9/09708; G03G 9/0819; G03G 9/0827; G03G 9/0821; G03G 15/0865

(57) ABSTRACT

A toner for developing an electrostatic charge image includes toner particles having an average circularity Cc of 0.80 or more and less than 0.98, and an external additive containing monodisperse silica particles and titanate compound particles, in which a ratio Rt/Rs of an average primary particle diameter Rt of the titanate compound particles to an average primary particle diameter Rs of the monodisperse silica particles is 0.50 or more and 3.50 or less, and a ratio A/B of an external additive coverage A (%) of the monodisperse silica particles on surfaces of the toner particles to an external additive coverage B (%) of the titanate compound particles on the surfaces of the toner particles satisfies formula (1): 0<A/B≤2.00.

### CROSS-REFERENCE TO RELATED APPLICATIONS

This application is based on and claims priority under 35 USC 119 from Japanese Patent Application No. 2021-156192 filed Sep. 24, 2021.

### BACKGROUND

### (i) Technical Field

The present disclosure relates to a toner for developing an electrostatic charge image, an electrostatic charge image developer, a toner cartridge, a process cartridge, and an image forming apparatus.

### (ii) Related Art

Japanese Unexamined Patent Application Publication No. 2005-148405 discloses a toner for electrophotography, the toner containing toner base particles that contain at least a releasing agent, a coloring agent, and a binder resin and that have an average particle diameter of 10 μm or less, strontium titanate fine particles, and hydrophobic inorganic fine particles having an average particle diameter equal to or greater than one tenth and equal to or less than one third of the average particle diameter of the strontium titanate fine particles, in which the strontium titanate fine particles and the hydrophobic inorganic fine particles are externally added to the toner base particles.

### SUMMARY

When a toner containing toner particles having an average circularity of less than 0.98 is put under a large load in a developing unit, the external additive sometimes move into recessed portions of the toner particles.

For example, when a low-density image (for example, an image density of 1%) is repeatedly formed in a low-temperature, low-humidity environment (for example, in an environment having a temperature of 10° C. and a humidity of 15%) under the conditions that warm-up operation is performed for every sheet (hereinafter, may also be referred to as the “low R/L conditions”), the toner is put under a large load in the developing unit. In the toner put under a large load in the developing unit, the externally added structure may notably change as the external additive moves into the recessed portions of the toner particles. Adding a new toner thereto may generate a triboelectric series difference between the newly added toner and the toner having the notably changed externally added structure, and may thereby cause a phenomenon in which the toner attaches and stays fixed to a non-image portion due to mutual electrification (this phenomenon may hereinafter be referred to as “fogging”).

Aspects of non-limiting embodiments of the present disclosure relate to a toner for developing an electrostatic charge image, the toner including toner particles having an average circularity Cc of 0.80 or more and less than 0.98 and an external additive containing monodisperse silica particles and titanate compound particles, with which fogging that occurs when a low-image-density image is repeatedly formed in a low-temperature, low-humidity environment under the low R/L conditions is suppressed compared to when the ratio Rt/Rs is less than 0.50 or more than 3.50, when the monodisperse silica particles contained in aggregates that contain the titanate compound particles account for, in terms of the number of particles, less than 20 number % of the monodisperse silica particles that are present on surfaces of the toner particles, or when the value A/B is more than 2.00.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a toner for developing an electrostatic charge image, the toner including toner particles having an average circularity Cc of 0.80 or more and less than 0.98, and an external additive containing monodisperse silica particles and titanate compound particles, in which a ratio Rt/Rs of an average primary particle diameter Rt of the titanate compound particles to an average primary particle diameter Rs of the monodisperse silica particles is 0.50 or more and 3.50 or less, and a ratio A/B of an external additive coverage A (%) of the monodisperse silica particles on surfaces of the toner particles to an external additive coverage B (%) of the titanate compound particles on the surfaces of the toner particles satisfies formula (1): 0<A/B≤2.00.

### BRIEF DESCRIPTION OF THE DRAWINGS

Exemplary embodiments of the present disclosure will be described in detail based on the following figures, wherein:

FIG. 1 is a schematic diagram illustrating an image forming apparatus according to an exemplary embodiment; and

FIG. 2 is a schematic diagram illustrating a process cartridge according to an exemplary embodiment.

### DETAILED DESCRIPTION

Exemplary embodiments, which are some of the examples of the present disclosure, will now be described. These descriptions and examples are merely illustrative and do not limit the scope of the present disclosure.

In this description, in numerical ranges described stepwise, the upper limit or the lower limit of one numerical range may be substituted with an upper limit or a lower limit of a different numerical range also described stepwise. In addition, in any numerical range described in the description, the upper limit or the lower limit of the numerical range may be substituted with a value indicated in Examples.

Each component may contain more than one corresponding substances.

When the amount of a component in a composition is described and when there are two or more substances that correspond to that component in the composition, the amount is the total amount of the two or more substances in the composition unless otherwise noted.

Toner for developing electrostatic charge image First exemplary embodiment

A toner for developing an electrostatic charge image according to a first exemplary embodiment (hereinafter the toner for developing an electrostatic charge image may be referred to as the “toner”) contains toner particles that have an average circularity Cc of 0.80 or more and less than 0.98, and an external additive that contains monodisperse silica particles and titanate compound particles. The ratio Rt/Rs of the average primary particle diameter Rt of the titanate compound particles to the average primary particle diameter Rs of the monodisperse silica particles is 0.50 or more and 3.50 or less, and the ratio A/B of the external additive coverage A % of the monodisperse silica particles on the toner particle surfaces to the external additive coverage B % of the titanate compound particles on the toner particle surfaces satisfies formula (1) below:

0<A/B≤2.00 Formula (1):

The external additive coverage of the monodisperse silica particles on the toner particle surfaces refers to the ratio (%) of the area covered with the monodisperse silica particles to the total surface area of the toner particles. The external additive coverage of the titanate compound particles on the toner particle surfaces refers to the ratio (%) of the area covered with the titanate compound particles to the total surface area of the toner particles.

As mentioned above, when a low-image-density image is repeatedly formed in a low-temperature, low-humidity environment under the low R/L conditions, the toner inside the developing unit is put under a large load, and the external additive on the toner particle surfaces moves in some cases. In particular, a toner containing toner particles having an average circularity of less than 0.98 has irregularities on the surfaces of the toner particles, and thus the external additive may move into recessed portions of the toner particles under a large load, and greatly change the externally added structure. Adding a new toner thereto may generate a triboelectric series difference between the newly added toner and the toner having the notably changed externally added structure, and may thereby cause fogging due to mutual electrification.

However, in this exemplary embodiment, the ratio Rt/Rs is within the aforementioned range, and A/B satisfies formula (1) above. Thus, fogging that occurs when a low-image-density image is repeatedly formed in a low-temperature, low-humidity environment under the low R/L conditions is suppressed. The reason for this is not exactly clear but is presumably as follows.

The titanate compound particles tend to gain positive charges as a result of triboelectric charging. Meanwhile, the monodisperse silica particles tend to gain negative charges as a result of triboelectric charging. Thus, when the ratio Rt/Rs is within the aforementioned range, the particle diameter of the titanate compound particles and the particle diameter of the monodisperse silica particles become similar, and thus the titanate compound particles and the monodisperse silica particles attract one another to form loose aggregates.

The titanate compound particles that have a larger specific gravity than the monodisperse silica particles rarely move on the surfaces of the toner particles and tend to stay fixed on protruding portions of the toner particle surfaces where the largest load is applied. Presumably thus, the monodisperse silica particles that form loose aggregates with the titanate compound particles among the monodisperse silica particles present on the protruding portions stay fixed on the protruding portions together with the titanate compound particles, and thus are inhibited from moving into recessed portions.

In addition, it is considered that, when A/B satisfies formula (1) mentioned above, the amount of independent monodisperse silica particles that are present on the toner particle surfaces without forming loose aggregates with the titanate compound particles is small. It is assumed that, due to this reason, even when the average circularity of the toner particles is less than 0.98, the titanate compound particles and the monodisperse silica particles present on the irregularities on the toner particle surfaces are more evenly distributed, the externally added structure does not notably changed under a large load, the triboelectric series difference is rarely generated, and fogging is suppressed.

Presumably due to the aforementioned reason, the toner for developing an electrostatic charge image according to the first exemplary embodiment suppresses fogging that occurs when a low-image-density image is repeatedly formed in a low-temperature, low-humidity environment under the low R/L conditions.

### Second Exemplary Embodiment

A toner for developing an electrostatic charge image according to a second exemplary embodiment contains toner particles that have an average circularity Cc of 0.80 or more and less than 0.98, and an external additive that contains monodisperse silica particles and titanate compound particles. In addition, the monodisperse silica particles that are contained in aggregates containing the titanate compound particles account for, in terms the number of particles, 20 number % or more of the monodisperse silica particles present on the surfaces of the toner particles.

Hereinafter, the ratio (%) of the number of monodisperse silica particles that are contained in the aggregates containing titanate compound particles relative to the monodisperse silica particles present on the surfaces of the toner particles may also be referred to as the “aggregated silica ratio”.

As mentioned above, when a low-image-density image is repeatedly formed in a low-temperature, low-humidity environment under the low R/L conditions, the toner inside the developing unit is put under a large load, and the external additive on the toner particle surfaces moves in some cases. In particular, a toner containing toner particles having an average circularity of less than 0.98 has irregularities on the surfaces of the toner particles, and thus the external additive may move into the recessed portions of the toner particles under a large load and may notably change the externally added structure. Adding a new toner thereto may generate a triboelectric series difference between the newly added toner and the toner having the notably changed externally added structure, and may thereby cause fogging due to mutual electrification.

However, in this exemplary embodiment, the aggregated silica ratio is within the aforementioned range. Thus, fogging that occurs when a low-image-density image is repeatedly formed in a low-temperature, low-humidity environment under the low R/L conditions is suppressed. The reason for this is not exactly clear but is presumably as follows.

Titanate compound particles tend to gain positive charges as a result of triboelectric charging whereas monodisperse silica particles tend to gain negative charges as a result of triboelectric charging; thus, the titanate compound particles and the monodisperse silica particles attract each other and may form loose aggregates. Moreover, the titanate compound particles that have a larger specific gravity rarely move on the surfaces of the toner particles compared to the monodisperse silica particles, and tend to stay fixed on the protruding portions of the toner particle surfaces where the highest load is applied. Presumably thus, the monodisperse silica particles that form loose aggregates with the titanate compound particles among the monodisperse silica particles present on the protruding portions stay fixed on the protruding portions together with the titanate compound particles, and thus are inhibited from moving into recessed portions.

The feature that the aggregated silica ratio is within the aforementioned range, in other words, that the ratio of the monodisperse silica particles contained in the aggregates containing titanate compound particles is high, means that, on the toner particle surfaces, there are many monodisperse silica particles that form loose aggregates with the titanate compound particles but few independent monodisperse silica particles that do not form loose aggregates with the titanate compound particles. Accordingly, as long as the aggregated silica ratio is within the aforementioned range, even when the average circularity of the toner particles is less than 0.98, the titanate compound particles and the monodisperse silica particles present on the irregularities on the toner particle surfaces are more evenly distributed, and presumably thus the externally added structure is less likely to change even under a large load. Presumably thus, the triboelectric series difference is rarely generated, and fogging is suppressed.

Presumably due to the aforementioned reasons, the toner for developing an electrostatic charge image according to the second exemplary embodiment suppresses fogging that occurs when a low-image-density image is repeatedly formed in a low-temperature, low-humidity environment under the low R/L conditions.

Hereinafter, a toner that corresponds to both the toner of the first exemplary embodiment and the toner of the second exemplary embodiment is described by referring to it as the “toner of the present exemplary embodiment”. However, one example of the toner of the present disclosure may be any toner that corresponds to at least one of the toner of the first exemplary embodiment and the toner of the second exemplary embodiment.

In the description below, the toner of the present exemplary embodiment is described in detail.

Toner Particles

Toner particles are formed of, for example, a binder resin, and, if needed, a coloring agent, a releasing agent, and other additives.

Binder Resin

Examples of the binder resin include vinyl resins, for example, homopolymers obtained from monomers such as styrenes (for example, styrene, parachlorostyrene, and α-methylstyrene) (meth)acrylates (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefines (for example, ethylene, propylene, and butadiene), and copolymers obtained from two or more of these monomers.

Other examples of the binder resin include non-vinyl resins such as epoxy resins, polyester resins, polyurethane resins, polyamide resins, cellulose resins, polyether resins, and modified rosin, mixtures of these non-vinyl resins and the aforementioned vinyl resins, and graft polymers obtained by polymerizing a vinyl monomer in the presence of these resins.

These binder resins may be used alone or in combination.

The binder resin may be a polyester resin.

Examples of the polyester resin include amorphous polyester resins known in the art. A combination of an amorphous polyester resin and a crystalline polyester resin may be used as the polyester resin.

In the present exemplary embodiment, the toner particles may contain a crystalline polyester resin. When the toner particles contain a crystalline polyester resin, fogging that occurs when a low-image-density image is repeatedly formed in a low-temperature, low-humidity environment under the low R/L conditions is further suppressed. The reason for this is not exactly clear but is presumably as follows.

In the aggregates of the titanate compound particles and the monodisperse silica particles that are present on the toner particle surfaces, the titanate compound particles that tend to gain positive charges as a result of triboelectric charging and the monodisperse silica particles that tend to gain negative charges as a result of triboelectric charging cancel charges with each other, but some charges may remain uncanceled on the toner particle surfaces. When charges remain in the aggregates, the aggregates repel one another and may more easily move on the toner particle surfaces.

However, when the toner particles contain a crystalline polyester resin, charges in the aggregates are removed due to the charge erasing property of the crystalline polyester resin, and repulsion between the aggregates is suppressed; it is thus considered that externally added structure rarely changes even under a large load, and fogging is suppressed.

The amount of the crystalline polyester resin used may be in the range of 2 mass % or more and 40 mass % or less (preferably 2 mass % or more and 20 mass % or less) relative to the entire binder resin.

Here, the term “crystalline” indicating the property of the resin means that the resin has a clear endothermic peak rather than a stepwise endothermic change in differential scanning calorimetry (DSC), and specifically means that the resin has a half width of 10° C. or less when measured at a temperature elevation rate of 10(° C./min).

In contrast, the term “amorphous” indicating the property of the resin means that the resin has a half width exceeding 10° C., exhibits a stepwise endothermic change, or has no clear endothermic peak.

Amorphous Polyester Resin

Examples of the amorphous polyester resins include polycondensation products formed between polycarboxylic acids and polyhydric alcohols. A commercially available product or a synthesized resin may be used as the amorphous polyester resin.

Examples of the polycarboxylic acids include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, and lower (for example, having 1 or more and 5 or less carbon atoms) alkyl esters thereof. Among these, an aromatic dicarboxylic acid may be used as the polycarboxylic acid.

A combination of a dicarboxylic acid and a tricarboxylic or higher polycarboxylic acid having a crosslinked or branched structure may be used as the polycarboxylic acid. Examples of the tricarboxylic or higher polycarboxylic acid include trimellitic acid, pyromellitic acid, anhydrides thereof, and lower (for example, having 1 or more and 5 or less carbon atoms) alkyl esters thereof.

These polycarboxylic acids may be used alone or in combination.

Examples of the polyhydric alcohols include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adducts of bisphenol A and propylene oxide adducts of bisphenol A). Among these, aromatic diols and alicyclic diols are preferred, and aromatic diols are more preferred as the polyhydric alcohols.

A trihydric or higher polyhydric alcohol having a crosslinked structure or a branched structure may be used in combination with a diol as the polyhydric alcohol. Examples of the trihydric or higher polyhydric alcohol include glycerin, trimethylolpropane, and pentaerythritol.

These polyhydric alcohols may be used alone or in combination.

The glass transition temperature (Tg) of the amorphous polyester resin is preferably 50° C. or higher and 80° C. or lower, and more preferably 50° C. or higher and 65° C. or lower.

The glass transition temperature is determined from a DSC curve obtained by differential scanning calorimetry (DSC), more specifically, according to “extrapolated glass transition onset temperature” described in the method for determining the glass transition temperature in JIS K 7121:1987 “Testing Methods for Transition Temperatures of Plastics”.

The weight average molecular weight (Mw) of the amorphous polyester resin is preferably 5,000 or more and 1,000,000 or less, and more preferably 7,000 or more and 500,000 or less.

The number average molecular weight (Mn) of the amorphous polyester resin may be 2,000 or more and 100,000 or less.

The molecular weight distribution Mw/Mn of the amorphous polyester resin is preferably 1.5 or more and 100 or less, and more preferably 2 or more and 60 or less.

The weight average molecular weight and the number average molecular weight are measured by gel permeation chromatography (GPC). The molecular weight measurement by GPC involves using GPCHLC-8120GPC produced by TOSOH CORPORATION as a measuring instrument with columns, TSKgel Super HM-M (15 cm) produced by TOSOH CORPORATION, and a THF solvent. The weight average molecular weight and the number average molecular weight are calculated from the measurement results by using the molecular weight calibration curves obtained from monodisperse polystyrene standard samples.

The amorphous polyester resin is obtained by a known production method. Specifically, for example, an amorphous polyester resin is obtained by performing a reaction at a polymerization temperature of 180° C. or higher and 230° C. or lower by reducing the pressure inside the reaction system as needed and by removing water and alcohols generated during condensation.

When the monomers used as raw materials do not dissolve or are not miscible at the reaction temperature, a high-boiling-point solvent may be used as a solubilizing agent to dissolve the monomers. In such a case, the polycondensation reaction is performed while distilling away the solubilizing agent. When there is a monomer that is poorly compatible, this poorly compatible monomer may be condensed in advance with an acid or an alcohol planned for polycondensation, and then the resulting product and other components may be subjected to polycondensation.

Crystalline Polyester Resin

Examples of the crystalline polyester resins include polycondensation products formed between polycarboxylic acids and polyhydric alcohols. A commercially available product or a synthesized resin may be used as the crystalline polyester resin.

In order to easily form a crystal structure, the crystalline polyester resin may be a polycondensate obtained by using a polymerizable monomer having a linear aliphatic group rather than a polymerizable monomer having an aromatic group.

Examples of the polycarboxylic acids include aliphatic dicarboxylic acids (for example, oxalic acid, succinic acid, glutaric acid, adipic acid, suberic acid, azelaic acid, sebacic acid, 1,9-nonandicarboxylic acid, 1,10-decandicarboxylic acid, 1,12-dodecandicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, and lower (for example, having 1 or more and 5 or less carbon atoms) alkyl esters thereof.

A combination of a dicarboxylic acid and a tricarboxylic or higher polycarboxylic acid having a crosslinked or branched structure may be used as the polycarboxylic acid. Examples of the tricarboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides thereof, and lower (for example, having 1 or more and 5 or less carbon atoms) alkyl esters thereof.

A combination of any of these dicarboxylic acids, a dicarboxylic acid having a sulfonic acid group, and a dicarboxylic acid having an ethylenic double bond may be used as the polycarboxylic acid.

These polycarboxylic acids may be used alone or in combination.

Examples of the polyhydric alcohol include aliphatic diols (for example, linear aliphatic diols having a main chain having 7 or more and 20 or less carbon atoms). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these, 1,8-octanediol, 1,9-nonanediol, or 1,10-decanediol may be used as an aliphatic diol.

A combination of a diol and a trihydric or higher alcohol having a crosslinked or branched structure may be used as the polyhydric alcohol. Examples of the trihydric or higher alcohol include glycerin, trimethylolethane, trimethylolpropane, and pentaerythritol.

These polyhydric alcohols may be used alone or in combination.

Here, in the polyhydric alcohol, the aliphatic diol content is preferably 80 mol % or more and more preferably 90 mol % or more.

The melting temperature of the crystalline polyester resin is preferably 50° C. or higher and 100° C. or lower, more preferably 55° C. or higher and 90° C. or lower, and yet more preferably 60° C. or higher and 85° C. or lower.

The melting temperature is determined from a DSC curve obtained by differential scanning calorimetry (DSC), more specifically, according to “Melting peak temperature” described in the method for determining the melting temperature in JIS K 7121:1987 “Testing Methods for Transition Temperatures of Plastics”.

The weight average molecular weight (Mw) of the crystalline polyester resin is preferably 6,000 or more and 35,000 or less.

The crystalline polyester resin is obtained by, for example, a known production method as with the amorphous polyester resin.

The binder resin content relative to the entirety of the toner particles is, for example, preferably 40 mass % or more and 95 mass % or less, more preferably 50 mass % or more and 90 mass % or less, and yet more preferably 60 mass % or more and 85 mass % or less.

Coloring Agent

Examples of the coloring agent include various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These coloring agents may be used alone or in combination.

The coloring agent may be surface-treated if necessary, and may be used in combination with a dispersing agent. Multiple types of coloring agents may be used in combination.

The coloring agent content relative to the entirety of the toner particles is preferably 1 mass % or more and 30 mass % or less and more preferably 3 mass % or more and 15 mass % or less.

Releasing Agent

Examples of the releasing agent include hydrocarbon wax, natural wax such as carnauba wax, rice wax, and candelilla wax, synthetic or mineral or petroleum wax such as montan wax, and ester wax such as fatty acid ester and montanic acid ester. The releasing agent is not limited to these.

The melting temperature of the releasing agent is preferably 50° C. or higher and 110° C. or lower, and more preferably 60° C. or higher and 100° C. or lower.

The melting temperature is determined from a DSC curve obtained by differential scanning calorimetry (DSC), more specifically, according to “Melting peak temperature” described in the method for determining the melting temperature in JIS K 7121:1987 “Testing Methods for Transition Temperatures of Plastics”.

The releasing agent content relative to the entirety of the toner particles is preferably 1 mass % or more and 20 mass % or less and more preferably 5 mass % or more and 15 mass % or less.

Other Additives

Examples of other additives include those known in the art such as a magnetic material, a charge controller, and inorganic powder. These additives are contained in the toner particles as internal additives.

Properties and other features of toner particles

The toner particles may have a single layer structure or a core-shell structure constituted by a core (core particle) and a coating layer (shell layer) covering the core.

The toner particles having a core-shell structure may be formed of, for example, a core containing a binder resin and other optional additives such as a coloring agent and a releasing agent, and a coating layer containing a binder resin.

The volume average particle diameter (D50v) of the toner particles may be 5 μm or more, may be 5 μm or more and 10 μm or less, or may be 5 μm or more and 8 μm or less.

The small diameter-side volume particle size distribution index (hereinafter may also be referred to as the “undersize GSDv”) of the toner particles may be 1.25 or more and is preferably 1.25 or more and 1.50 or less. When the small diameter-side volume particle size distribution is within the aforementioned range, the coating of the external additive on the toner particles becomes substantially even, the charge distribution becomes sharp, and the effect of suppressing fogging that occurs when a low-image-density image is repeatedly formed in a low-temperature, low-humidity environment under the low R/L conditions is easily exhibited.

The undersize GSDv is a value calculated from the formula below:

Undersize GSDv=(D50v/D16v)^{1/2} Formula:

In the formula above, D16v and D50v respectively represent the particle diameter (D16v) at a cumulative volume of 16% and the particle diameter (D50v) at a cumulative volume of 50% in a cumulative distribution drawn from the small diameter side based on the particle size distribution.

Various average particle diameters and various particle size distribution indices of the toner particles are measured by using COULTER MULTISIZER II (produced by Beckman Coulter Inc.) and ISOTON-II (produced by Beckman Coulter Inc.) as the electrolyte.

In measuring, a 0.5 mg or more and 50 mg or less of a measurement sample is added to 2 mL of a 5% aqueous solution of a surfactant (sodium alkylbenzene sulfonate) serving as a dispersing agent. The resulting mixture is added to 100 mL or more and 150 mL or less of the electrolyte.

The electrolyte in which the sample is suspended is dispersed for 1 minute by using an ultrasonic disperser, and the particle size distribution of particles having a particle diameter in the range of 2 μm or more and 60 μm or less is measured by using Coulter MULTISIZER II with an aperture having a diameter of 100 μm. The number of sampled particles is 50,000.

Cumulative distributions of the volume and the number of particles are plotted from the small diameter size relative to the particle size ranges (channels) divided on the basis of the particle size distributions to be measured. Then the particle diameters at a cumulation of 16% are defined as the volume particle diameter D16v and the number particle diameter D16p, the particle diameters at a cumulation of 50% are defined as the volume average particle diameter D50v and the cumulative number average particle diameter D50p, and the particle diameters at a cumulation of 84% are defined as the volume particle diameter D84v and the number particle diameter D84p.

The average circularity Cc of the toner particles may be 0.80 or more and less than 0.98, 0.90 or more and 0.98 or less, or 0.93 or more and 0.98 or less.

The average circularity Cc of the toner particles is determined from (circle-equivalent perimeter)/(perimeter) [(perimeter of a circle having the same projection area as the particle image)/(perimeter of a particle projection image)]. Specifically, it is the value measured by the following method.

First, toner particles to be measured are collected by suction, and are allowed to form a flat flow. Particle images are captured as still images by performing instantaneous strobe light emission, and these particle images are analyzed by a flow-type particle image analyzer (FPIA-3000 produced by Sysmex Corporation) to determine the average circularity. In determining the average circularity Cc, 3500 particles are sampled.

When the toner contains an external additive, the toner (developer) to be measured is dispersed in surfactant-containing water, and then ultrasonically treated to obtain toner particles from which the external additive have been removed.

When the toner particles contain a crystalline polyester resin, the exposure ratio of the crystalline polyester resin on the surfaces of the toner particles is preferably 2% or more and 10% or less, more preferably 3% or more and 9% or less, and yet more preferably 4% or more and 9% or less.

When exposure ratio of the crystalline polyester resin is within the aforementioned range, fogging that occurs when a low-image-density image is repeatedly formed in a low-temperature, low-humidity environment under the low R/L conditions is further suppressed compared to when the exposure ratio is below the aforementioned range. The reason for this is presumably that, due to a high exposure ratio of the crystalline polyester resin, the charge erasing effect of the crystalline polyester resin is easily obtained.

In addition, when the exposure ratio of the crystalline polyester resin is within the aforementioned range, the charge maintaining property is improved compared to when the exposure ratio is beyond the aforementioned range. The reason for this is presumably that the crystalline polyester resin has low electrical resistance, and an excessively high exposure ratio may cause a decrease in charges. It is also assumed that, because the exposure ratio of the crystalline polyester resin is within the aforementioned range, extensive fogging caused by the decrease in charges is suppressed.

The exposure ratio of the crystalline polyester resin on the surfaces of the toner particles is measured as follows.

Specifically, the surfaces of the toner particles are stained with osmium tetroxide or ruthenium tetroxide in a desiccator. The toner particles with stained surfaces are observed with a scanning electron microscope (SEM). Regions where the crystalline polyester resin is exposed and regions where the crystalline polyester resin is not exposed are distinguished by shades generated by the extent of staining the resin with osmium tetroxide or ruthenium tetroxide, and the exposure ratio of the crystalline polyester resin is determined on the basis of the shades. Specifically, the ratio (%) of the area of the regions where the crystalline polyester resin is exposed to the area of the entire toner particle surface is assumed to be the exposure ratio (%) of the crystalline polyester resin.

When an external additive is externally added to the surfaces of the toner particles to be measured, measurement is conducted after removing the external additive by performing ultrasonic treatment for 20 minutes together with a mixed solution containing ion exchange water and a surfactant, removing the surfactant, drying the toner particles, and recovering the toner particles. The treatment for removing the external additive may be repeated until the removal of the external additive is completed.

External Additive

The external additive contains monodisperse silica particles and titanate compound particles.

Monodisperse Silica Particles

The monodisperse silica particles may be any particles that contain silica, in other words, SiO₂, as a main component. In this description, the “main component” refers to a component that accounts for 50 mass % or more of the total mass of the mixture containing multiple components.

In this description the term “monodisperse” refers to a state in which the particle size distribution index described below is 1.25 or less.

The average primary particle diameter Rs of the monodisperse silica particles may be 20 nm or more and 70 nm or less.

When the average primary particle diameter Rs of the monodisperse silica particles is within the aforementioned range, sinking of the monodisperse silica particles into the toner particles that occurs when a low-image-density image is continuously formed is suppressed compared to when the average primary particle diameter Rs is below the aforementioned range. As a result, degradation of the transfer efficiency, the decrease in charges, degradation of image quality, and other issues caused by sinking of the monodisperse silica particles into the toner particles are suppressed.

In addition, when the average primary particle diameter Rs of the monodisperse silica particles is within the aforementioned range, detachment of the monodisperse silica particles from the toner particles that occurs when a high-image-density image is continuously formed is suppressed compared to when the average primary particle diameter Rs is beyond the aforementioned range. As a result, the decrease in charges caused by the detached monodisperse silica particles moving toward the carrier, degradation of the image quality caused by the change in the external additive structure, etc., are suppressed.

The average primary particle diameter Rs of the monodisperse silica particles is preferably 25 nm or more and 70 nm or less and more preferably 30 nm or more and 65 nm or less.

The particle size distribution index of the monodisperse silica particles is 1.25 or less.

From the viewpoints of further suppressing aggregation of the monodisperse silica particles and suppressing fogging that occurs when a low-image-density image is repeatedly formed in a low-temperature, low-humidity environment under the low R/L conditions, the particle size distribution index of the monodisperse silica particles is preferably 1.05 or more and 1.25 or less, more preferably 1.05 or more and 1.2 or less, and yet more preferably 1.05 or more and 1.15 or less.

Here, the average primary particle diameter and the particle size distribution index of the monodisperse silica particles are measured by the following methods.

Primary particles obtained by dispersing silica particles to be measured in resin particle bodies (for example, a polyester resin, weight average molecular weight Mw=500,000) having a volume average particle diameter of 100 μm are observed with a scanning electron microscope (SEM) (S-4100 produced by Hitachi Corporation), and an image is captured (magnification: 40,000×). Two hundred silica particles to be measured are selected at random, the image information thereof is captured into an image analyzer (Winroof), the area of each particle is measured by image analysis, and the circle-equivalent diameter is calculated from the area value. In the volume-based cumulative frequency of the circle-equivalent diameter obtained, the 50% diameter is assumed to be the average primary particle diameter.

Next, in the volume-based cumulative frequency of the circle-equivalent diameter obtained, the 16% diameter (D16) and the 84% diameter (D84) are determined. The square root of the value obtained by dividing 84% diameter (D84) by the 16% diameter (D16) is assumed to be the particle size distribution index(=(D84/D16)^{1/2}). The magnification of the electron microscope is adjusted so that 10 or more and 50 or less of silica particles to be measured are within the field of view, and the circle-equivalent diameter of the primary particles is determined by combining observation of several fields of view.

The surfaces of the monodisperse silica particles may be hydrophobized. Hydrophobizing involves, for example, immersing monodisperse silica particles in a hydrophobizing agent. The hydrophobizing agent is not particularly limited, and examples thereof include known organic silicon compounds that have alkyl groups (for example, a methyl group, an ethyl group, a propyl group, or a butyl group), specifically, silane coupling agents such as silazane compounds (for example, silane compounds such as methyltrimethoxysilane, dimethyldimethoxysilane, trimethylchlorosilane, and trimethylmethoxysilane; hexamethyldisilazane, and tetramethyldisilazane). Other examples of the hydrophobizing agent include silicone oil, titanate coupling agents, and aluminum coupling agents. These agents may be used alone or in combination.

The amount of the hydrophobizing agent is, for example, 1 part by mass or more and 200 parts by mass or less relative to 100 parts by mass of the monodisperse silica particles.

The monodisperse silica particle content relative to the mass of the toner particles is preferably 0.01 mass % or more and 10 mass % or less, more preferably 0.05 mass % or more and 5 mass % or less, and yet more preferably 0.1 mass % or more and 2.5 mass % or less.

Production of monodisperse silica particles

The monodisperse silica particles may be produced by a wet method.

In the present exemplary embodiment, the “wet method” is distinguished from a vapor phase method, and involves neutralizing sodium silicate with a mineral acid or hydrolyzing alkoxysilane.

Of the wet methods, a sol-gel method may be employed to produce the monodisperse silica particles.

Hereinafter, a method for producing monodisperse silica particles used in the present exemplary embodiment is described by taking a sol-gel method as an example.

However, the method for producing the monodisperse silica particles is not limited to this sol-gel method.

The particle diameter of the monodisperse silica particles can be freely controlled by adjusting the weight ratios of alkoxysilane, ammonia, alcohol, and water, the reaction temperature, the stirring speed, and the feed speed in the hydrolysis and polycondensation step of the sol-gel method.

Hereinafter, a method for producing monodisperse silica particles by a sol-gel method is described specifically.

That is, tetramethoxysilane is added dropwise and stirred in the presence of water and alcohol while being catalyzed by ammonia water under heating. Next, the solvent is removed from the silica sol suspension obtained by the reaction, and the residue is dried to obtain the target monodisperse silica particles.

Subsequently, the obtained monodisperse silica particles are hydrophobized as needed.

When the monodisperse silica particles are to be produced by a sol-gel method, the surfaces of the silica particles may be hydrophobized simultaneously.

In such a case, as described above, the silica sol suspension obtained by the reaction is centrifugally separated into wet silica gel, alcohol, and ammonia water, and a solvent is added to the wet silica gel to again form a silica sol. Then a hydrophobizing agent is added to the silica sol to hydrophobize the surfaces of the silica particles. Next, the solvent is removed from this hydrophobized silica sol, and the residue is dried to obtain the target monodisperse silica particles.

The monodisperse silica particles obtained as such may again be hydrophobized.

Examples of the hydrophobizing treatment performed on the silica particle surfaces include a dry method such as a spray dry method that involves spraying a hydrophobizing agent or a hydrophobizing agent-containing solution onto silica particles allowed to float in a vapor phase, a wet method that involves immersing silica particles in a hydrophobizing agent-containing solution and drying the resulting silica particles, and a mixing method that involves mixing a hydrophobizing agent and silica particles using a mixer.

Furthermore, a step of washing the silica particles with a solvent to remove the remaining hydrophobizing agent and low-boiling-point residues may be added after the hydrophobizing treatment on the silica particle surfaces.

Titanate Compound Particles

The titanate compound particles may be any particles that contain a titanate compound as a main component.

A titanate compound is called a metatitanate and is a salt generated from, for example, titanium oxide and another metal oxide or carbonate.

The titanate compound particles may be alkaline earth metal titanate particles.

Here, alkaline earth metal titanate is a salt represented by general formula RTiO₃ (where R represents at least one alkaline earth metal).

Using alkaline earth metal titanate particles as the titanate compound particles shortens the time needed to reach the saturation charge, and fogging that occurs when a low-image-density image is repeatedly formed in a low-temperature, low-humidity environment under the low R/L conditions is further suppressed.

Specific examples of the titanate compound particles include particles of strontium titanate (SrTiO₃), calcium titanate (CaTiO₃), magnesium titanate (MgTiO₃), barium titanate (BaTiO₃), and lead titanate (PbTiO₃).

From the viewpoint of further suppressing fogging that occurs when a low-image-density image is repeatedly formed in a low-temperature, low-humidity environment under the low R/L conditions, the titanate compound particles may be at least one type of particles selected from the group consisting of strontium titanate particles, calcium titanate particles, and magnesium titanate particles.

These titanate compound particles may be used alone or in combination.

The average primary particle diameter Rt of the titanate compound particles may be 20 nm or more and 70 nm or less.

When the average primary particle diameter Rt of the titanate compound particles is within the aforementioned range, sinking of the titanate compound particles into the toner particles that occurs when a low-image-density image is continuously formed is suppressed compared to when the average primary particle diameter Rt is below the aforementioned range. As a result, degradation of the transfer efficiency, the decrease in charges, degradation of image quality, and other issues caused by sinking of the titanate compound particles into the toner particles are suppressed.

In addition, when the average primary particle diameter Rt of the titanate compound particles is within the aforementioned range, detachment of the titanate compound particles from the toner particles that occurs when a high-image-density image is continuously formed is suppressed compared to when the average primary particle diameter Rt is beyond the aforementioned range. As a result, the decrease in charges caused by the detached titanate compound particles moving toward the carrier, degradation of the image quality caused by the change in the external additive structure, etc., are suppressed.

The average primary particle diameter Rt of the titanate compound particles is preferably 25 nm or more and 70 nm or less and more preferably 30 nm or more and 65 nm or less.

Here, the way in which the average primary particle diameter of the titanate compound particles is calculated is the same as calculating the average primary particle diameter of the monodisperse silica particles.

The titanate compound particles may contain a dopant.

When the titanate compound particles contain a dopant, the crystallinity of the titanate compound decreases, and the shape of the titanate compound particles becomes appropriately angular. As a result, for example, the average circularity Cb of the titanate compound particles easily falls within the range of more than 0.78 and less than 0.94. Thus, the titanate compound particles are more likely to stay fixed on the toner particle surfaces. As a result, detachment of the titanate compound particles from the toner particles is further suppressed. Presumably due to the aforementioned features, fogging that occurs when a low-image-density image is repeatedly formed in a low-temperature, low-humidity environment under the low R/L conditions is further suppressed.

The dopant for the titanate compound particles may be metal element that has an ionic radius with which the metal element in an ionized state can enter the crystal structure of the titanate compound particles. From this viewpoint, the dopant of the titanate compound particles is preferably a metal element that has an ionic radius of 40 μm or more and 200 μm or less when ionized, and is more preferably a metal element that has an ionic radius of 60 μm or more and 150 μm or less when ionized.

Specific examples of the dopant for the titanate compound particles include lanthanoids, silica, aluminum, magnesium, calcium, barium, vanadium, chromium, manganese, iron, cobalt, nickel, copper, zinc, gallium, niobium, molybdenum, ruthenium, palladium, indium, antimony, tantalum, tungsten, rhenium, iridium, platinum, bismuth, yttrium, zirconium, niobium, silver, and tin. Lanthanum or cerium is preferable as the lanthanoid. Among these, at least one selected from lanthanum and silica is preferable as the dopant since the ionic radius thereof allows the element to easily enter the crystal structure constituting the strontium titanate particles and the shape of the titanate compound becomes appropriately angular.

The amount of the dopant in the titanate compound particles relative to the alkaline earth metal atoms contained in the titanate compound particles is preferably within the range of 0.1 mol % or more and 20 mol % or less, more preferably within the range of 0.1 mol % or more and 15 mol % or less, and yet more preferably within the range of 0.1 mol % or more and 10 mol % or less from the viewpoint of rendering an appropriately angular shape to the titanate compound.

The surfaces of the titanate compound particles may be hydrophobized. Examples of the hydrophobizing agent include known surface treatment agents, specifically, for example, silane coupling agents and silicone oil.

Examples of the silane coupling agent include hexamethyldisilazane, trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, γ-methacryloxypropyltrimethoxysilane, and vinyltriacetoxysilane.

Examples of the silicone oil include dimethylpolysiloxane, methylhydrogenpolysiloxane, and methylphenylpolysiloxane.

The titanate compound particle content relative to the monodisperse silica particle content is preferably 0.1 or more and 20 or less, more preferably 0.2 or more and 18 or less, and yet more preferably 0.3 or more and 15 or less in terms of mass ratio.

The titanate compound particle content relative to the mass of the toner particles is preferably 0.01 mass % or more and 10 mass % or less, more preferably 0.05 mass % or more and 8 mass % or less, and yet more preferably 0.1 mass % or more and 5 mass % or less.

Production of Titanate Compound Particles

The method for producing the titanate compound particles is not particularly limited but is preferably a wet method from the viewpoint of controlling the particle diameter and the shape.

The wet method for the titanate compound particles involves performing a reaction while an alkaline aqueous solution is added to a liquid mixture of the sources of the metal elements to be contained in the titanate compound, and then performing an acid treatment, for example. In this production method, the particle diameter of the titanate compound particles is controlled by the ratios of mixing the metal element sources, the metal element source concentrations at the initial stage of the reaction, the temperature and the speed for adding the alkaline aqueous solution, etc.

Here, examples of the metal element sources to be contained in the titanate compound include mineral acid peptization products of titanium compound hydrolysates and nitrates and chlorides of metal elements other than titanium.

Specifically, when the titanate compound particles are alkaline earth metal titanate particles, examples of the metal element sources include mineral acid peptization products of titanium compound hydrolysates and nitrates and chlorides containing alkaline earth metal elements.

More specifically, when the titanate compound particles are strontium titanate particles, examples thereof include mineral acid peptization products (hereinafter may also be referred to as a titanium source) of titanium compound hydrolysates, and strontium nitrate and strontium chloride (hereinafter may also be referred to as a strontium source).

In the description below, a method for producing strontium titanate particles is described as one example of the method for producing the titanate compound particles, but the method is not limited to this.

The mixing ratio for the titanium oxide source and the strontium source in terms of SrO/TiO₂ molar ratio is preferably 0.9 or more and 1.4 or less and more preferably 1.05 or more and 1.20 or less. The titanium oxide source concentration at the initial stage of the reaction in terms of TiO₂ is preferably 0.05 mol/L or more and 1.3 mol/L or less and more preferably 0.5 mol/L or more and 1.0 mol/L or less.

A dopant source may be added to the liquid mixture of the titanium oxide source and the strontium source. Examples of the dopant source include an oxide of a metal other than titanium and strontium. The metal oxide serving as the dopant source is added as a solution prepared by dissolving the metal oxide in nitric acid, hydrochloric acid, sulfuric acid, or the like, for example. The amount of the dopant source added is preferably adjusted so that the amount of the metal serving as the dopant is preferably 0.1 mol or more and 10 mol or less and more preferably 0.5 mol or more and 10 mol or less relative to 100 mol of strontium.

Addition of the dopant may take place when the alkaline aqueous solution is added to the liquid mixture of the titanium oxide source and the strontium source. In this case also, the oxide of the metal serving as the dopant source may be added as a solution prepared by dissolving the metal oxide in nitric acid, hydrochloric acid, or sulfuric acid.

The alkaline aqueous solution may be an aqueous sodium hydroxide solution. There is a tendency that the higher the temperature during addition of the alkaline aqueous solution, the better the crystallinity of the strontium titanate particles obtained; thus, the temperature in the present exemplary embodiment may be 60° C. or higher and 100° C. or lower.

As for the speed of adding the alkaline aqueous solution, the lower the speed, the larger the diameter of the strontium titanate particles obtained, and the higher the speed, the smaller the diameter of the strontium titanate particles obtained. The speed of adding the alkaline aqueous solution relative to the loaded raw materials is, for example, 0.001 eq/h or more and 1.2 eq/h or less, and a speed of 0.002 eq/h or more and 1.1 eq/h or less is appropriate.

After adding the alkaline aqueous solution, an acid treatment is performed to remove the unreacted strontium source. The acid treatment involves, for example, adjusting the pH of the reaction solution to 2.5 to 7.0 and more preferably to 4.5 to 6.0 by using hydrochloric acid.

After the acid treatment, the reaction solution is separated into a solid and a liquid, and the solid component is dried to obtain strontium titanate particles.

The water content of the strontium titanate particles is controlled by adjusting the conditions of drying the solid component.

When the surfaces of the strontium titanate particles are to be hydrophobized, the water content may be controlled by adjusting the conditions of the drying treatment performed after the hydrophobizing treatment.

Here, the drying conditions for controlling the water content are preferably, for example, a drying temperature of 90° C. or higher and 300° C. or lower (preferably 100° C. or higher and 150° C. or lower) and a drying time of 1 hour or longer and 15 hours or shorter (preferably 5 hours or longer and 10 hours or shorter).

Hydrophobizing Treatment

The hydrophobizing treatment performed on the surfaces of the strontium titanate particles involves preparing a treatment solution by mixing a hydrophobizing agent and a solvent, mixing the treatment solution with strontium titanate particles under stirring, and then further continuing stirring.

After the surface treatment, a drying treatment is performed to remove the solvent in the treatment solution.

Examples of the hydrophobizing agent are those described above.

The solvent used in preparing the treatment solution may be an alcohol (for example, methanol, ethanol, propanol, or butanol), a hydrocarbon (for example, benzene, toluene, normal hexane, or normal heptane), or the like.

The hydrophobizing agent concentration in the treatment solution is preferably 1 mass % or more and 50 mass % or less, more preferably 5 mass % or more and 40 mass % or less, and yet more preferably 10 mass % or more and 30 mass % or less.

The amount of the hydrophobizing agent used in the hydrophobizing treatment relative to the mass of the strontium titanate particles is preferably 1 mass % or more and 50 mass % or less, more preferably 5 mass % or more and 40 mass % or less, yet more preferably 5 mass % or more and 30 mass % or less, and still more preferably 10 mass % or more and 25 mass % or less, as mentioned above.

Other External Additives

The toner used in the present exemplary embodiment may contain, as additional external additives, particles other than the aforementioned monodisperse silica particles and titanate compound particles.

Examples of the particles include inorganic particles other than silica particles and titanate compound particles.

Examples of the inorganic particles include Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surfaces of the inorganic particles serving as an additional external additive may be hydrophobized. Hydrophobizing involves, for example, immersing inorganic particles in a hydrophobizing agent. The hydrophobizing agent may be any, and examples thereof include silane coupling agents, silicone oils, titanate coupling agents, and aluminum coupling agents. These agents may be used alone or in combination.

The amount of the hydrophobizing agent relative to 100 parts by mass of the inorganic particles may be 1 part by mass or more and 10 parts by mass or less.

Other examples of the other particles include resin particles (resin particles of polystyrene, polymethyl methacrylate, melamine resin, etc.), and cleaning activating agents (for example, particles of fluorine polymers).

When an additional external additive is to be contained, the content of the additional external additive relative to the total content of the external additives is preferably 1 mass % or more and 99 mass % or less, more preferably 10 mass % or more and 90 mass % or less, and yet more preferably 20 mass % or more and 85 mass % or less.

Relationship between physical property values of external additives

### Average Primary Particle Diameter Ratio

The ratio Rt/Rs of the average primary particle diameter Rt of the titanate compound particles to the average primary particle diameter Rs of the monodisperse silica particles is 0.5 or more and 3.5 or less. From the viewpoint of further suppressing fogging that occurs when a low-image-density image is repeatedly formed in a low-temperature, low-humidity environment under the low R/L conditions, the ratio Rt/Rs is preferably 0.6 or more and 2.00 or less, more preferably 0.7 or more and 1.50 or less, and yet more preferably 0.80 or more and 1.20 or less.

Average Circularity Ca and Average Circularity Cb

The average circularity Ca of the monodisperse silica particles may be more than 0.86 and less than 0.94, and the average circularity Cb of the titanate compound particles may be more than 0.78 and less than 0.94.

When the average circularities of the monodisperse silica particles and the titanate compound particles are within the aforementioned ranges, fogging that occurs when a low-image-density image is repeatedly formed in a low-temperature, low-humidity environment under the low R/L conditions is further suppressed.

The reasons for this are presumably as follows.

When the average circularity Ca of the monodisperse silica particles and the average circularity Cb of the titanate compound particles are within the aforementioned ranges, both the monodisperse silica particles and the titanate compound particles can easily take appropriately irregular shapes. Thus, the monodisperse silica particles and the titanate compound particles are inhibited from rolling on the toner particles, and rarely move toward the carrier and toward the recessed portions in the toner particle surfaces even when a large load is applied inside the developing unit. It is presumed from what is described above that, when the values of the average circularity Ca of the monodisperse silica particles and the average circularity Cb of the titanate compound particles are within the aforementioned ranges, fogging that occurs when a low-image-density image is repeatedly formed in a low-temperature, low-humidity environment under the low R/L conditions is further suppressed.

From the viewpoint of further suppressing fogging that occurs when a low-image-density image is repeatedly formed in a low-temperature, low-humidity environment under the low R/L conditions, the average circularity Ca of the monodisperse silica particles is preferably 0.87 or more and 0.93 or less and more preferably 0.88 or less and 0.92 or less.

From the viewpoint of further suppressing fogging that occurs when a low-image-density image is repeatedly formed in a low-temperature, low-humidity environment under the low R/L conditions, the average circularity Cb of the titanate compound particles is preferably 0.79 or more and 0.93 or less and more preferably 0.80 or more and 0.92 or less.

The average circularity Ca of the monodisperse silica particles may be larger than the average circularity Cb of the titanate compound particles.

When the average circularity Ca of the monodisperse silica particles and the average circularity Cb of the titanate compound particles have this relationship, the shape of the titanate compound particles tends to be appropriately angular compared to the monodisperse silica particles. As a result, the titanate compound particles are more likely to stay fixed on the toner particle surfaces compared to the monodisperse silica particles. Meanwhile, the monodisperse silica particles are likely to take a rounded shape compared to the titanate compound particles. As a result, compared to the titanate compound particles, the monodisperse silica particles tend to roll on the toner particle surfaces and form loose aggregates with the titanate compound particles fixed on the protruding portions and the recessed portions of the toner particle surfaces. As a result, the monodisperse silica particles are likely to be present on both the protruding portions and recessed portions of the toner particle surfaces, and movement toward the recessed portions is suppressed. It is presumed from what is described above that, when the average circularity Ca of the monodisperse silica particles is larger than the average circularity Cb of the titanate compound particles, fogging that occurs when a low-image-density image is repeatedly formed in a low-temperature, low-humidity environment under the low R/L conditions is further suppressed.

From the viewpoint of further suppressing fogging that occurs when a low-image-density image is repeatedly formed in a low-temperature, low-humidity environment under the low R/L conditions, the difference (Ca−Cb) between the average circularity Ca of the monodisperse silica particles and the average circularity Cb of the titanate compound particles is preferably 0.01 or more and 0.16 or less, more preferably 0.03 or more and 0.15 or less, and yet more preferably 0.05 or more and 0.14 or less.

Here, the average circularities of the monodisperse silica particles and the titanate compound particles are measured by the following method.

The particles (monodisperse silica particles or titanate compound particles) to be measured externally added to the surfaces of the toner particles are observed with a scanning electron microscope (SEM) (S-4100 produced by Hitachi Corporation), and an image is captured (magnification: 40,000×). Two hundred silica particles to be measured are selected at random, the image information thereof is captured into an image analyzer (Winroof), and the average circularity is calculated from the obtained plan image analysis of primary particles using the following formula.

circularity=(4π×A)/I² Formula:

[where I represents a perimeter of a primary particle on the image, and A represents the projected area of the primary particle.]

The average circularity of the particles (monodisperse silica particles or titanate compound particles) to be measured is obtained as a 50% circularity in a cumulative frequency of circularity of two hundred primary particles obtained by the plan image analysis described above.

When the average circularities of the monodisperse silica particles and the titanate compound particles before external addition to the toner particles are to be measured, the primary particles may be observed after the particles to be measured (monodisperse silica particles or titanate compound particles) are dispersed in resin particle bodies (for example, a polyester resin, weight average molecular weight Mw=500000) having a volume average particle diameter of 100 μm.

Specific Gravity Da of Monodisperse Silica Particles and Specific Gravity Db of Titanate Compound Particles

The specific gravity Da of the monodisperse silica particles may be 1.1 or more and 1.3 or less, and the specific gravity Db of the titanate compound particles may be larger than the specific gravity Da of the monodisperse silica particles.

When the specific gravity Da of the monodisperse silica particles and the specific gravity Db of the titanate compound particles have the aforementioned relationship, fogging that occurs when a low-image-density image is repeatedly formed in a low-temperature, low-humidity environment under the low R/L conditions is further suppressed.

The reasons for this are presumably as follows.

When the specific gravity Db of the titanate compound particles is larger than the specific gravity Da of the monodisperse silica particles, the titanate compound particles are preferentially attached to the toner particle surfaces during the time when the monodisperse silica particles and the titanate compound particles are externally added to the toner particles. As a result, the monodisperse silica particles tend to form loose aggregates with the titanate compound particles fixed on the protruding portions and the recessed portions of the toner particles, and thus are likely to exist on both the protruding portions and the recessed portions of the toner particle surfaces while movement toward the recessed portions is suppressed. It is presumed from what is described above that, when the specific gravities of the monodisperse silica particles and the titanate compound particles are within the aforementioned ranges, fogging that occurs when a low-image-density image is repeatedly formed in a low-temperature, low-humidity environment under the low R/L conditions is further suppressed.

The specific gravity Db of the titanate compound particles is preferably 4.0 or more and 6.5 or less, more preferably 4.1 or more and 5.5 or less, and yet more preferably 4.2 or more and 5.0 or less.

When the specific gravity Db of the titanate compound particles is within the aforementioned numerical range, the adhesiveness of the titanate compound particles to the toner particle surfaces is further improved. Thus, the monodisperse silica particles and the titanate compound particles are further inhibited from detaching from the toner particles, and movement of the monodisperse silica particles into the recessed portions in the toner particle surfaces is further suppressed. Presumably thus, fogging that occurs when a low-image-density image is repeatedly formed in a low-temperature, low-humidity environment under the low R/L conditions is further suppressed.

From the viewpoint of further suppressing fogging that occurs when a low-image-density image is repeatedly formed in a low-temperature, low-humidity environment under the low R/L conditions, the difference (Db−Da) between the specific gravity Da of the monodisperse silica particles and the specific gravity Db of the titanate compound particles is preferably 2.7 or more and 5.4 or less, more preferably 3.0 or more and 5.0 or less, and yet more preferably 3.5 or more and 4.5 or less.

The specific gravity Da of monodisperse silica particles and the specific gravity Db of titanate compound particles are measured in accordance with JIS K 0061 (2001) by using a Le Chatelier flask. The procedure is as follows.
(1) Into a Le Chatelier flask, about 250 ml of ethyl alcohol is placed such that the meniscus comes at the position of the scale mark.
(2) The flask is immersed in a constant-temperature water vessel, and the position of the meniscus at a liquid temperature of 20.0 ±0.2° C. is accurately read by the marks on the flask. (The accuracy is to be 0.025 ml.)
(3) A sample of about 100 g is weighed, and the mass thereof is assumed to be W (g).
(4) The weighed sample is placed in the flask, and bubbles are removed.
(5) The flask is immersed in a constant-temperature water vessel, and the position of the meniscus at a liquid temperature of 20.0 ±0.2° C. is accurately read by the marks on the flask. (The accuracy is to be 0.025 ml.)
(6) The specific gravity is calculated from the following formula:

D=W/(L2−L1)

ρ=D/0.9982

In the formula, D represents the density (20° C.) (g/cm³) of the sample, ρ represents the specific gravity (20° C.) of the sample, W represents the apparent mass (g) of the sample, L1 represents the reading (20° C.) (ml) of the meniscus before the sample is placed in the flask, L2 represents the reading (20° C.) (ml) after the sample is placed in the flask, and 0.9982 is the density (g/cm³) of water at 20° C.

External Additive Coverage of Monodisperse Silica Particles and External Additive Coverage of Titanate Compound Particles

The ratio A/B of the external additive coverage A % of the monodisperse silica particles on the toner particle surfaces to the external additive coverage B % of the titanate compound particles on the toner particle surfaces satisfies formula (1) below. From the viewpoint of further suppressing fogging that occurs when a low-image-density image is repeatedly formed in a low-temperature, low-humidity environment under the low R/L conditions, A/B preferably satisfies formula (2) below, more preferably satisfies formula (3) below, and yet more preferably satisfies formula (4) below:

0<A/B≤2.00 Formula (1):

0.05≤A/B≤1.50 Formula (2):

0.10≤A/B≤1.20 Formula (3):

0.20≤A/B≤1.00 Formula (4):

The external additive coverage A % of the monodisperse silica particles is, for example, in the range of 5% or more and 50% or less, is more preferably in the range of 5% or more and 40% or less, is yet more preferably in the range of 5% or more and 20% or less, and is still more preferably in the range of 5% or more and 15% or less.

When the external additive coverage A % of the monodisperse silica particles is within the aforementioned range, fogging that occurs when a low-image-density image is repeatedly formed in a low-temperature, low-humidity environment under the low R/L conditions is further suppressed compared to when the external additive coverage A % is beyond the aforementioned range. Although the reason for this is not clear, the reason is presumably that the amount of silica particles that do not form loose aggregates with the titanate compound particles but remain independent on the toner particle surfaces is decreased.

In addition, when the external additive coverage A % of the monodisperse silica particles is within the aforementioned range, the toner exhibits better flowability than when the external additive coverage A % is below the aforementioned range.

The external additive coverage A % of the monodisperse silica particles is, for example, controlled by adjusting the amount of the monodisperse silica particles added, the external addition conditions (for example, the stirring speed and the mixing time when a Henschel mixer is used), etc.

The external additive coverage B % of the titanate compound particles is, for example, in the range of 5% or more and 50% or less, is preferably in the range of 5% or more and 40% or less, is more preferably in the range of 8% or more and 30% or less, and is yet more preferably in the range of 10% or more and 20% or less.

When the external additive coverage B % of the titanate compound particles is within the aforementioned range, fogging that occurs when a low-image-density image is repeatedly formed in a low-temperature, low-humidity environment under the low R/L conditions is further suppressed compared to when the external additive coverage B % is below the aforementioned range. Although the reason for this is not clear, the reason is presumably that the amount of silica particles that do not form loose aggregates with the titanate compound particles but remain independent on the toner particle surfaces is decreased.

In addition, when the external additive coverage B % of the titanate compound particles is within the aforementioned range, the charge maintaining property improves compared to when the external additive coverage B % is beyond the aforementioned range. The reason for this is probably that the titanate compound particles have low electrical resistance and may cause a decrease in charges when the amount of coating is excessively large; thus, controlling the external additive coverage B % to the aforementioned range suppresses degradation of fogging caused by the decrease in charges.

The external additive coverage B % of the titanate compound particles is, for example, controlled by adjusting the amount of the titanate compound particles added, the external addition conditions (for example, the stirring speed and the mixing time when a Henschel mixer is used), etc.

The external additive coverage A % of the monodisperse silica particles and external additive coverage B % of the titanate compound particles are determined as follows.

The toner is observed with a scanning electron microscope (SEM) device (S-4700 produced by Hitachi Corporation) at a magnification of 50000× for 100 fields of view, and an image is taken. From the obtained SEM image, the total surface area of toner particles, the area of the regions where the monodisperse silica particles are attached, and the area of the regions where the titanate compound particles are attached are calculated.

In the aforementioned SEM image, the regions where the monodisperse silica particles are attached, the regions where the titanate compound particles are attached, and the regions where neither the monodisperse silica particles nor the titanate compound particles are attached are identified as follows. Specifically, by using an energy dispersive X-ray analyzer EMAX model 16923H (produced by Horiba Ltd.) attached to the electron microscope S4100, mapping analysis is conducted at an acceleration voltage of 20 kV to identify the type of the external additive, and the area of the image of the external additives is determined.

Next, the coverage ratio of each of the external additives is calculated according to the following formulae.

A (%)=(area of regions where monodisperse silica particles are attached)/(total surface area of toner particles)×100 Formula (5):

B (%)=(area of regions where titanate compound particles are attached)/(total surface area of toner particles)×100 Formula (6):

Ratio of Number of Monodisperse Silica Particles Contained in Aggregates Containing Titanate Compound Particles

The monodisperse silica particles that are contained in aggregates containing the titanate compound particles account for 20 number % or more of the monodisperse silica particles present on the surfaces of the toner particles in terms the number of particles; in other words, the aggregated silica ratio is 20 number % or more.

The aggregated silica ratio is preferably 20 number % or more and 70 number % or less, more preferably 30 number % or more and 65 number % or less, and yet more preferably 40 number % or more and 60 number % or less. When the aggregated silica ratio is within the aforementioned range, fogging that occurs when a low-image-density image is repeatedly formed in a low-temperature, low-humidity environment under the low R/L conditions is further suppressed compared to when the aggregated silica ratio is below the aforementioned range. In addition, when the aggregated silica ratio is within the aforementioned range, excessively uneven distribution of the monodisperse silica does not occur, the charge distribution becomes sharp, and fogging is suppressed as a result.

The aggregated silica ratio is determined as follows.

The toner is observed with a scanning electron microscope (SEM) device (S-4700 produced by Hitachi Corporation) at a magnification of 50000× for 100 fields of view, and an image is taken. From the SEM image obtained by imaging, among the external additive attached to the toner particles, the number of all monodisperse silica particles present on the surfaces of the toner particles and the number of monodisperse silica particles contained in the aggregates containing titanate compound particles are determined, and then the aggregated silica ratio is determined from formula (7) below.

Aggregated silica ratio (%)=(number of monodisperse silica particles contained in aggregates containing titanate compound particles)/(number of all monodisperse silica particles present on surfaces of toner particles)×100 Formula (7):

Note that, in the aforementioned SEM image, the regions where the monodisperse silica particles are present, the regions where the titanate compound particles are present, and the regions where neither the monodisperse silica particles nor the titanate compound particles are present are identified as follows. Specifically, by using an energy dispersive X-ray analyzer EMAX model 16923H (produced by Horiba Ltd.) attached to the electron microscope S4100, mapping analysis is conducted at an acceleration voltage of 20 kV to identify the type of the external additive.

Method for Producing Toner

Next, a method for producing the toner according to the present exemplary embodiment is described.

The toner of the present exemplary embodiment is obtained by first producing toner particles and then externally adding an external additive to the toner particles.

The toner particles may be produced by a dry method (for example, a kneading and pulverizing method) or a wet method (for example, an aggregation and coalescence method, a suspension polymerization method, or a dissolution and suspension method). The method for producing the toner particles may be any, and any known method may be employed.

Among these, the kneading and pulverizing method may be employed to produce the toner particles from the viewpoint of obtaining toner particles having an average circularity Cc of less than 0.98.

Specifically, for example, when toner particles are to be produced by a kneading and pulverizing method, toner particles are produced through a kneading step of melt-kneading constituent components of the toner particles that contain a binder resin and a releasing agent and the like that are used as necessary, a cooling step of cooling the melt-kneaded product, a pulverizing step of pulverizing the cooled kneaded product, and a classifying step of classifying the pulverized product.

These steps will now be described in detail. Note that although a method for obtaining toner particles containing a coloring agent and a releasing agent is described below, the coloring agent and the releasing agent are optional and used as necessary. Naturally, additives other than the coloring agent and the releasing agent may also be used.

Kneading Step

The kneading step involves melt-kneading constituent components (toner particle-forming materials) that contain a binder resin, a coloring agent, and a releasing agent to thereby obtain a kneaded product.

Examples of the kneader used in the kneading step include a three-roll kneader, a one-screw kneader, a twin-screw kneader, and a Banbury mixer kneader.

The melting temperature may be determined on the basis of the types of the binder resin and the releasing agent to be kneaded, the blend ratio, etc.

In the kneading step, 0.5 parts by mass or more and 5 parts by mass or less of an aqueous medium (for example, water such as distilled water and ion exchange water, and alcohol) may be added to 100 parts by mass of the toner particle-forming materials.

Cooling Step

The cooling step involves cooling a kneaded product formed in the aforementioned kneading step.

In the cooling step, in order to keep the dispersed state immediately after completion of the kneading step, the kneaded product may be cooled from the temperature of immediately after completion of the kneading to a temperature equal to or lower than 40° C. at an average temperature decrease rate of 4° C./sec or more.

The average temperature decrease rate refers to the average value of the rate in which the temperature is caused to decrease from the temperature of the kneaded product immediately after the completion of the kneading step to a temperature of 40° C.

An example of the cooling method employed in the cooling step is a method that uses a rolling roll and a sandwich-type cool belt and the like in which cold water or brine is circulated. When cooling is to be performed by the aforementioned method, the cooling rate is determined by the speed of the rolling roll, the flow rate of the brine, the amount of the kneaded product supplied, the slab thickness of the kneaded product during rolling, etc. The slab thickness may be 1 mm or more and 3 mm or less.

Pulverizing Step

The kneaded product cooled in the cooling step is pulverized in the pulverizing step to thereby form particles.

In the pulverizing step, for example, a mechanical pulverizer, a jet pulverizer, or the like is used.

If necessary, particles obtained in the pulverizing step may be heat-treated with hot air or the like.

Furthermore, if necessary, surfaces of at least one type of particles selected from the particles obtained in the pulverizing step and the particles obtained in the classifying step described below may be coated with a resin. The surfaces of the particles may be coated with resin by using, for example, a dry-type particle combining apparatus that causes resin particles to mechanically collide with the surfaces of the particles.

Classifying Step

The particles obtained in the pulverizing step may be classified in the classifying step as needed.

In the classifying step, a centrifugal classifier, an inertial classifier, or the like that has been used in the past is used, and fine particles (particles having a diameter smaller than the target range) and coarse particles (particles having a diameter larger than the target range) are removed.

The toner particles are obtained through the aforementioned steps.

The toner of the present exemplary embodiment is produced, for example, by adding an external additive to the obtained toner particles and mixing the resulting mixture. Mixing may be performed by using a V blender, a HENSCHEL mixer, a Lodige mixer, or the like, for example. Furthermore, if needed, a vibrating screen, an air screen, or the like may be used to remove coarse particles from the toner.

Electrostatic Charge Image Developer

The electrostatic charge image developer of the present exemplary embodiment contains at least the toner according to the present exemplary embodiment.

The electrostatic charge image developer of the present exemplary embodiment may be a one-component developer that contains only the toner of the present exemplary embodiment, or a two-component developer that contains the toner and a carrier.

The carrier may be any known carrier. Examples of the carrier include a coated carrier obtained by covering a surface of a core formed of a magnetic powder with a coating resin; a magnetic powder-dispersed carrier in which a magnetic powder is dispersed and blended in a matrix resin; and a resin-impregnated carrier in which a porous magnetic powder is impregnated with a resin.

The magnetic powder-dispersed carrier and the resin-impregnated carrier may each be constituted by a core formed of a constituent particle of the carrier, and a coating resin covering the core.

Examples of the magnetic powder include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylate copolymer, an organosiloxane bond-containing straight silicone resin and modified products thereof, a fluororesin, polyester, polycarbonate, phenolic resin, and epoxy resin.

The coating resin and the matrix resin may each contain other additives such as conductive particles.

Examples of the conductive particles include particles of metals such as gold, silver, and copper, and particles of carbon black, titanium oxide, zinc oxide, tin oxide, barium sulfate, aluminum borate, and potassium titanate.

Here, an example of the method for coating the surface of the core with a resin include a method that involves coating the surface of the core with a coating layer-forming solution prepared by dissolving a coating resin and, if needed, various additives in an appropriate solvent. The solvent is not particularly limited, and may be selected in view of the type of the coating resin used, application suitability, etc.

Specific examples of the resin coating method include a dipping method that involves dipping a core in a coating layer-forming solution, a spraying method that involves spraying a coating layer-forming solution onto the surface of the core, a flow bed method that involves spraying a coating layer-forming solution while the core floats on flowing air, and a kneader coater method that involves mixing the core for the carrier and a coating layer-forming solution in a kneader coater and removing the solvent.

The toner-to-carrier mixing ratio (mass ratio) in the two-component developer is preferably 1:100 to 30:100, and more preferably 3:100 to 20:100.

Image Forming Apparatus and Image Forming Method

An image forming apparatus and an image forming method according to exemplary embodiments will now be described.

An image forming apparatus according to an exemplary embodiment includes an image bearing member, a charging unit that charges a surface of the image bearing member, an electrostatic charge image forming unit that forms an electrostatic charge image on the charged surface of the image bearing member, a developing unit that stores an electrostatic charge image developer and develops the electrostatic charge image on the surface of the image bearing member into a toner image by using the electrostatic charge image developer, a transfer unit that transfers the toner image on the surface of the image bearing member onto a surface of a recording medium, and a fixing unit that fixes the transferred toner image on the surface of the recording medium. The electrostatic charge image developer of the present exemplary embodiment is employed as the electrostatic charge image developer.

The image forming apparatus of the present exemplary embodiment is used to implement an image forming method (the image forming method of the present exemplary embodiment) that involves a charging step of charging a surface of an image bearing member, an electrostatic charge image forming step of forming an electrostatic charge image on the charged surface of the image bearing member, a developing step of developing the electrostatic charge image on the surface of the image bearing member into a toner image by using the electrostatic charge image developer of the exemplary embodiment, a transfer step of transferring the toner image on the surface of the image bearing member onto a surface of a recording medium, and a fixing step of fixing the transferred toner image on the surface of the recording medium.

The image forming apparatus of the present exemplary embodiment may be, for example, a known image forming apparatus such as a direct transfer type apparatus with which a toner image formed on a surface of an image bearing member is directly transferred onto a recording medium; an intermediate transfer type apparatus with which a toner image formed on a surface of an image bearing member is first transferred onto a surface of an intermediate transfer body and then the toner image on the intermediate transfer body is transferred for the second time onto a surface of a recording medium; an apparatus equipped with a cleaning unit that cleans the surface of an image bearing member after the transfer of the toner image and before charging; or an apparatus equipped with a charge erasing unit that irradiates the surface of an image bearing member with charge erasing light to remove charges after the transfer of the toner image and before charging.

When the intermediate transfer type apparatus is used, the transfer unit has a structure that includes an intermediate transfer body having a surface that receives the transfer of a toner image, a first transfer unit that performs first transfer of transferring the toner image on the surface of the image bearing member onto a surface of the intermediate transfer body, and a second transfer unit that performs second transfer of transferring the transferred toner image on the surface of the intermediate transfer body onto a surface of a recording medium.

In the image forming apparatus of the present exemplary embodiment, a portion that includes the developing unit may have a cartridge structure (process cartridge) detachably attachable to the image forming apparatus. An example of the process cartridge is a process cartridge equipped with a developing unit that stores the electrostatic charge image developer of the present exemplary embodiment.

Hereinafter, one example of the image forming apparatus of the exemplary embodiment is described, but this exemplary embodiment is not limiting. Only the relevant parts in the drawing are described, and descriptions for other parts are omitted.

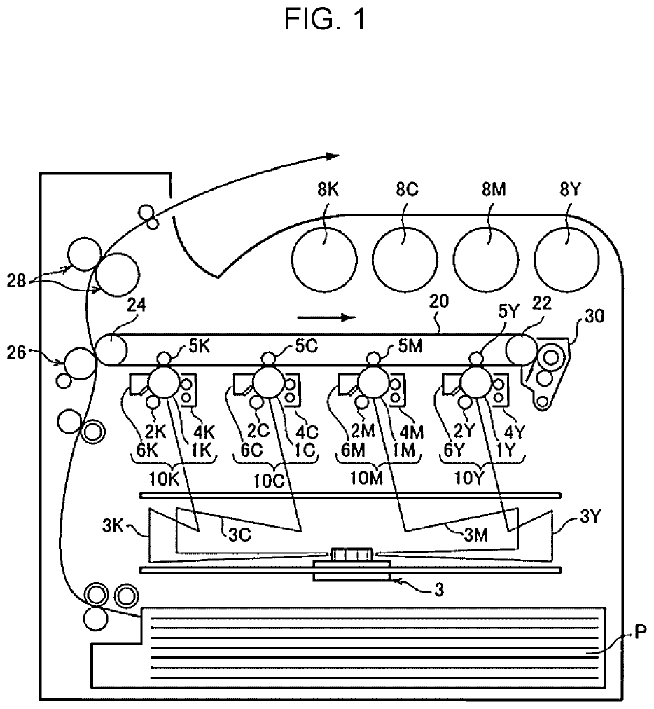

FIG. 1 is a schematic diagram illustrating an image forming apparatus according to an exemplary embodiment.

An image forming apparatus illustrated in FIG. 1 is equipped with electrophotographic first to fourth image forming units 10Y, 10M, 10C, and 10K (image forming units) that output images of respective colors, yellow (Y), magenta (M), cyan (C), and black (K), on the basis of the color separated image data. These image forming units (hereinafter may be simply referred to as “units”) 10Y, 10M, 10C, and 10K are spaced from one another by predetermined distances in the horizontal direction and arranged side-by-side. The units 10Y, 10M, 10C, and 10K may be process cartridges detachably attachable to the image forming apparatus.

An intermediate transfer belt 20 serving as an intermediate transfer body extends above all of the units 10Y, 10M, 10C, and 10K in the drawing. The intermediate transfer belt 20 is wound around a driving roll 22 and a supporting roll 24 arranged to be spaced from each other in the left-to-right direction in the drawing, and runs in the direction from the first unit 10Y toward the fourth unit 10K. The supporting roll 24 is in contact with the inner surface of the intermediate transfer belt 20. The supporting roll 24 is urged to be away from the driving roll 22 by a spring or the like not illustrated in the drawing, so that a tension is applied to the intermediate transfer belt 20 wound around the two rolls. An intermediate transfer body cleaning device 30 that opposes the driving roll 22 is disposed on the image-bearing-member-side surface of the intermediate transfer belt 20.

In addition, toners of four colors, yellow, magenta, cyan, and black, are supplied from toner cartridges 8Y, 8M, 8C, and 8K to developing devices (developing units) 4Y, 4M, 4C, and 4K of the units 10Y, 10M, 10C, and 10K.

Since the first to fourth units 10Y, 10M, 10C, and 10K are identical in structure, the first unit 10Y that is disposed on the upstream side in the intermediate transfer belt running direction and forms a yellow image is described as a representative example. The parts equivalent to those of the first unit 10Y are represented by the same reference signs followed by magenta (M), cyan (C), or black (K) instead of yellow (Y), and descriptions of the second to fourth units 10M, 10C, and 10K are omitted.

The first unit 10Y includes a photoreceptor 1Y that serves as an image bearing member. The photoreceptor 1Y are surrounded by, in order of arrangement, a charging roll (one example of the charging unit) 2Y that charges a surface of the photoreceptor 1Y to a predetermined potential, an exposing device (one example of the electrostatic charge image forming unit) 3 that exposes the charged surface of the photoreceptor 1Y with a laser beam 3Y on the basis of the color-separated image signal so as to form an electrostatic charge image, a developing device (one example of the developing unit) 4Y that develops the electrostatic charge image by supplying a charged toner to the electrostatic charge image, a first transfer roll (one example of the first transfer unit) 5Y that transfers the developed toner image onto the intermediate transfer belt 20, and a cleaning device (one example of the cleaning unit) 6Y that removes the toner remaining on the surface of the photoreceptor 1Y after the first transfer.

The first transfer roll 5Y is disposed on the inner side of the intermediate transfer belt 20 and positioned to oppose the photoreceptor 1Y. Furthermore, bias power supplies (not illustrated) that apply first transfer biases are respectively connected to the first transfer rolls 5Y, 5M, 5C, and 5K. A controller not illustrated in the drawing controls each of the bias power supplies so that the transfer bias applied to the first transfer roll is variable.

Hereinafter, operation of forming a yellow image in the first unit 10Y is described.

First, before starting operation, the surface of the photoreceptor 1Y is charged by the charging roll 2Y to a potential in the range of −600 V to −800 V.

The photoreceptor 1Y is formed by stacking a photosensitive layer on a conductive (for example, volume resistivity at 20° C.: 1×10⁻⁶ Ωcm or less) base. This photosensitive layer normally has a high resistance (a resistance of a general resin); however, once irradiated with a laser beam 3Y, the portion exposed to the laser beam exhibits a change in resistivity. Next, the charged surface of the photoreceptor 1Y is irradiated with a laser beam 3Y emitted from the exposing device 3 on the basis of the yellow image data transmitted from a controller not illustrated in the drawings. The photosensitive layer constituting the surface of the photoreceptor 1Y is irradiated with the laser beam 3Y, and an electrostatic charge image having a yellow image pattern is thereby formed on the surface of the photoreceptor 1Y.

An electrostatic charge image is an image formed on the surface of the photoreceptor 1Y as a result of charging, and is a negative latent image formed as the decrease in the resistivity of the irradiated portion of the photosensitive layer causes the charges to flow out from the surface of the photoreceptor 1Y while the charges in the portions not irradiated with the laser beam 3Y remain.

The electrostatic charge image formed on the photoreceptor 1Y is rotated to a predetermined developing position as the photoreceptor 1Y is run. At that developing position, the electrostatic charge image on the photoreceptor 1Y is visualized by the developing device 4Y into a toner image (developed image).

The developing device 4Y stores an electrostatic charge image developer that contains at least a yellow toner and a carrier. The yellow toner is frictionally charged by being stirred in the developing device 4Y, and is held on the developer roll (one example of the developer carrying member) while the yellow toner has charges of the same polarity (negative polarity) as the charges on the photoreceptor 1Y. As the surface of the photoreceptor 1Y passes the developing device 4Y, the yellow toner electrostatically adheres to the latent image portion from which the charges on the surface of the photoreceptor 1Y have been removed, and the latent image is developed with the yellow toner. The photoreceptor 1Y on which the yellow toner image is formed is continuously run at a predetermined speed, and the developed toner image on the photoreceptor 1Y is conveyed to a predetermined first transfer position.

Once the yellow toner image on the photoreceptor 1Y is conveyed to the first transfer position, a first transfer bias is applied to the first transfer roll 5Y, an electrostatic force acting from the photoreceptor 1Y toward the first transfer roll 5Y acts on the toner image, and the toner image on the photoreceptor 1Y is transferred onto the intermediate transfer belt 20. The transfer bias applied here has a polarity (+) opposite to the polarity (−) of the toner, and, in the first unit 10Y, for example, is controlled at +10 μA by a controller (not illustrated).

Meanwhile, the toner remaining on the photoreceptor 1Y is removed by the photoreceptor cleaning device 6Y and recovered.

The first transfer biases applied to the first transfer rolls 5M, 5C, and 5K of the second unit 10M and onwards are also controlled as with the first unit.

The intermediate transfer belt 20, onto which a yellow toner image is transferred in the first unit 10Y, sequentially passes the second to fourth units 10M, 10C, and 10K, and toner images of respective colors are stacked on top of each other to perform multilayer transfer.

After the multilayer transfer of toner images of four colors through the first to fourth units, the intermediate transfer belt 20 reaches a second transfer portion constituted by the intermediate transfer belt 20, the supporting roll 24 in contact with the inner surface of the intermediate transfer belt 20, and a second transfer roll (one example of the second transfer unit) 26 disposed on the image-retaining-surface-side of the intermediate transfer belt 20. Meanwhile, a recording sheet (one example of the recording medium) P is fed, via a feeder mechanism, to a contact gap between the second transfer roll 26 and the intermediate transfer belt 20 at a predetermined timing, and a second transfer bias is applied to the supporting roll 24. The transfer bias applied here has the same polarity (−) as the polarity o(−) of the toner, an electrostatic force from the intermediate transfer belt 20 acting toward the recording sheet P acts on the toner images, and the toner images on the intermediate transfer belt 20 are transferred onto the recording sheet P. Here, the second transfer bias is determined according to the resistance of the second transfer portion detected by a resistance detection unit (not illustrated), and is controlled by voltage.

Subsequently, the recording sheet P is conveyed to a contact portion (nip portion) of a pair of fixing rolls in a fixing device (one example of the fixing unit) 28 where the toner images are fixed to the recording sheet P and a fixed image is formed.

Examples of the recording sheet P onto which the toner images are transferred include regular paper used in electrophotographic copiers and printers. Examples of the recording medium also include OHP sheets and the like in addition of the recording sheet P.

In order to further improve the smoothness of the image surface after fixing, the surface of the recording sheet P may be smooth. For example, coated paper obtained by coating the surface of regular paper with a resin or the like, art paper for printing, and the like may be used.

After completion of fixing of the color image, the recording sheet P is conveyed toward a discharge portion, and a series of color image forming operation steps are completed.

Process Cartridge/Toner Cartridge

A process cartridge according to an exemplary embodiment will now be described.

The process cartridge according to this exemplary embodiment is detachably attachable to an image forming apparatus, and includes a developing unit that stores the electrostatic charge image developer of the exemplary embodiment and develops an electrostatic charge image on a surface of an image bearing member into a toner image by using the electrostatic charge image developer.

The process cartridge of the exemplary embodiment is not limited to the aforementioned structure, and may include a developing device and, if needed, at least one unit selected from an image bearing member, a charging unit, an electrostatic charge image forming unit, transfer unit, and other units, for example.

Hereinafter, one example of the process cartridge of the exemplary embodiment is described, but this example is not limiting. Only the relevant parts in the drawing are described, and descriptions for other parts are omitted.

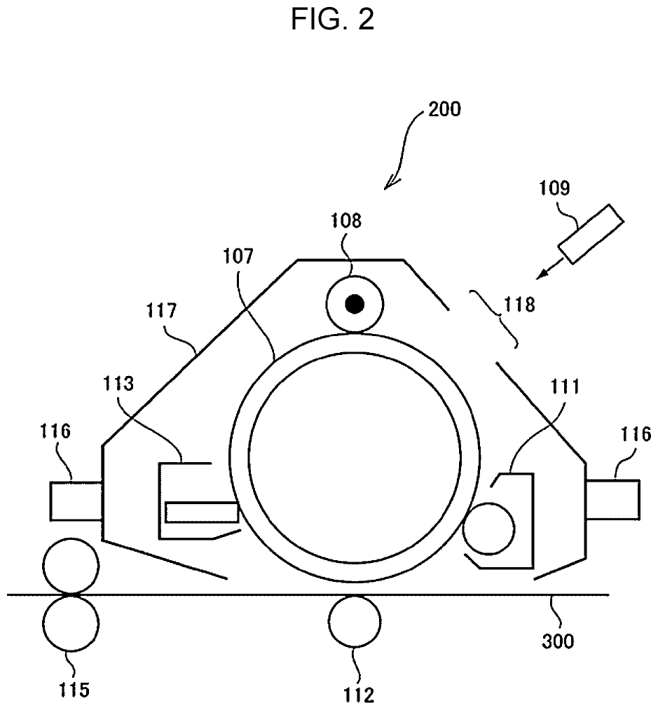

FIG. 2 is a schematic diagram illustrating a process cartridge according to an exemplary embodiment.

A process cartridge 200 illustrated in FIG. 2 is a cartridge obtained by using a housing 117 equipped with a guide rail 116 and an exposure opening 118 so as to integrate a photoreceptor 107 (one example of the image bearing member), and a charging roll 108 (one example of the charging unit), a developing device 111 (one example of the developing unit), and a photoreceptor cleaning device 113 (one example of the cleaning unit) provided around the photoreceptor 107.

Note that, in FIG. 2, 109 denotes an exposure device (one example of the electrostatic charge image forming unit), 112 denotes a transfer device (one example of the transfer unit), 115 denotes a fixing device (one example of the fixing unit), and 300 denotes a recording sheet (one example of the recording medium).

Next, a toner cartridge according to an exemplary embodiment is described.

The toner cartridge according to this exemplary embodiment stores the toner of the exemplary embodiment and is detachably attachable to an image forming apparatus. The toner cartridge stores replenishing toner to be supplied to a developing unit disposed inside the image forming apparatus.

Note that the image forming apparatus illustrated in FIG. 1 has detachably attachable toner cartridges 8Y, 8M, 8C, and 8K that are respectively connected to the developing devices 4Y, 4M, 4C, and 4K of the corresponding colors via toner supply tubes not illustrated in the drawing. In addition, when the toner level in the toner cartridge has run low, the cartridge is replaced.

### EXAMPLES

Examples will now be described, but these examples do not limit the scope of the present disclosure. In the description below, “parts” and “%” are on a mass basis unless otherwise noted.

Toner Particles (A)

### Production of Amorphous Polyester Resin 1

Into a 4 L four-necked glass flask, 76.9 parts by mass (0.167 mol) of polyoxypropylene(2.2)-2,2-bis(4-hydroxyphenyl)propane, 24.1 parts by mass (0.145 mol) of terephthalic acid, and 0.5 parts by mass of titanium tetrabutoxide are placed, a thermometer, a stirring rod, a condenser, and a nitrogen inlet tube are attached thereto, and the flask is placed in a mantle heater. After the flask is purged with nitrogen gas, the temperature is slowly elevated while stirring the content, and the reaction is carried out for 3.5 hours at a temperature of 200° C. under stirring (first reaction step). Subsequently, 2.0 parts by mass (0.010 mol) of trimellitic anhydride is added, and the reaction is carried out at 180° C. for 1 hour (second reaction step) to obtain an amorphous polyester resin 1.

The amorphous polyester resin 1 has an acid value of 10 mgKOH/g and a hydroxyl value of 65 mgKOH/g. As for the molecular weights measured by GPC, the weight average molecular weight (Mw) is 7,800, the number average molecular weight (Mn) is 3,300, and the peak molecular weight (Mp) is 5,500.

Production of Amorphous Polyester Resin 2

Into a 4 L four-necked glass flask, 71.3 parts by mass (0.155 mol) of polyoxypropylene(2.2)-2,2-bis(4-hydroxyphenyl)propane, 24.1 parts by mass (0.145 mol) of terephthalic acid, and 0.6 parts by mass of titanium tetrabutoxide are placed, a thermometer, a stirring rod, a condenser, and a nitrogen inlet tube are attached thereto, and the flask is placed in a mantle heater. After the flask is purged with nitrogen gas, the temperature is slowly elevated while stirring the content, and the reaction is carried out for 2 hours at a temperature of 200° C. under stirring (first reaction step). Subsequently, 5.8 parts by mass (0.030 mol %) of trimellitic anhydride is added, and the reaction is carried out at 180° C. for 9 hours (second reaction step) to obtain an amorphous polyester resin 2.

The amorphous polyester resin 2 has an acid value of 15 mgKOH/g and a hydroxyl value of 7 mgKOH/g. As for the molecular weights measured by GPC, the weight average molecular weight (Mw) is 190,000, the number average molecular weight (Mn) is 5,000, and the peak molecular weight (Mp) is 10,000.

Production of Styrene Acryl Resin 3
Low-density polyethylene (Mw: 1380, Mn: 840, maximum endothermic peak by DSC: 100° C.): 18 parts by mass
Styrene: 66 parts by mass
n-Butyl acrylate: 13.5 parts by mass
Acrylonitrile: 2.5 parts by mass
   The aforementioned materials are charged in an autoclave, the inside of the system is purged with nitrogen, and the temperature is elevated to and retained at 180° C. while stirring the content. Into the system, 50 parts by mass of a 2 mass % xylene solution of t-butylhydroperoxide is added dropwise continuously for 4.5 hours, and the solvent is separated and removed after cooling to thereby obtain a styrene acryl resin 3 as a result of the reaction between the aforementioned low-density polyethylene and the vinyl resin component. The molecular weights of the styrene acryl resin 3 are measured. The weight average molecular weight (Mw) is 7000, and the number average molecular weight (Mn) is 3000.

Production of Crystalline Polyester Resin 4
Decanedioic acid: 81 parts
Hexanediol: 47 parts

The aforementioned materials are placed in a flask, and the temperature is elevated to 160° C. over a period of 1 hour. After confirming that the interior of the reaction system is evenly stirred, 0.03 parts of dibutyltin oxide is added. The temperature is elevated to 200° C. over a period of 6 hours while distilling away generated water, and stirring is continued for 4 hours at 200° C. Next, the reaction solution is cooled and subjected to solid-liquid separation. The solid matter is dried at a temperature of 40° C. at a reduced pressure to thereby obtain a crystalline polyester resin 4 (melting temperature: 64° C., weight average molecular weight: 15,000).

Production of Toner Particles (A)
Amorphous polyester resin 1: 50.0 parts by mass
Amorphous polyester resin 2: 50.0 parts by mass
Styrene acryl resin 3: 5.0 parts by mass
Crystalline polyester resin 4: 2.0 parts by mass
Fischer-Tropsch wax (DSC maximum endothermic peak: 76° C.): 6.0 parts by mass
C.I. Pigment Blue 15:3: 5.0 parts by mass
Aluminum 3,5-di-t-butylsalicilate compound: 0.5 parts by mass

The raw materials prescribed above are mixed in a Henschel mixer (model FM-75, produced by NIPPON COKE & ENGINEERING. CO., LTD.) at a rotation rate of 20 s⁻¹ for a rotation time of 5 minutes to obtain a toner composition (A). Next, the composition is kneaded in a twin-screw kneader (model PCM-30 produced by Ikegai Corp) set to a temperature of 125° C. to obtain a melt-kneaded product (A). The obtained melt-kneaded product (A) is cooled, roughly pulverized in a hammer mill to 1 mm or smaller, and then finely pulverized in a mechanical pulverizer (T-250 produced by Turbo Corporation) to obtain finely pulverized product (A).

The obtained pulverized product (A) is subjected to a surface modification treatment by using a surface modification apparatus hybridization system (produced by Nara Machinery Co., Ltd.) or a mechanofusion system (produced by Hosokawa Micron Corporation) to obtain a target circularity.

Next, coarse particles are eliminated by using a fixed-screen-type air sifter to obtain toner particles (A). A metal screen having a diameter of 30 cm, a screen opening of 20 μm, and an average wire diameter of 30 μm is installed in a fixed-screen-type air sifter, and the toner particles are allowed to flow on a stream at an air speed of 5 Nm³/min while being supplied at a treatment amount of 150 kg/hr, and directly collected with a bag filter. The pressure difference between the inlet and the outlet of the screen is 1.0 kPa.

The volume average particle diameter (D50v) of the toner particles (A) is 6.74 μm, the small-diameter-side volume particle size distribution index (undersize GSDv) is 1.41, the average circularity Cc is 0.952, and the exposure ratio of the crystalline polyester resin on the surfaces is 8.61%.

Toner Particles (B)

Toner particles (B) are obtained as with the toner particles (A) except that the crystalline polyester resin 4 is not used.

The volume average particle diameter (D50v) of the toner particles (B) is 6.77 μm, the small-diameter-side volume particle size distribution index (undersize GSDv) is 1.40, the average circularity Cc is 0.950, and the exposure ratio of the crystalline polyester resin on the surfaces is 0%.

Monodisperse Silica Particles (S1)

### Preparation of Silica Particle Dispersion (1)

Into a glass reactor equipped with a stirrer, a dropping nozzle, and a thermometer, 320 parts of methanol and 72 parts of 10% ammonia water are added and mixed to obtain an alkali catalyst solution. This alkali catalyst solution is adjusted to 34° C. (dropping starting temperature) and stirred during which 45 parts of tetramethoxysilane and 9 parts of 8% ammonia water are simultaneously added dropwise to thereby obtain a hydrophilic silica particle dispersion (solid content: 12%). The dropping time is set to 10 minutes. The obtained silica particle dispersion is concentrated down to a solid content of 40% by using a rotary filter R-Fine (produced by Kotobuki Industries Co., Ltd.). The concentrated product is used as the silica particle dispersion (1).

Preparation of Monodisperse Silica Particles (S1)

Silica particles are surface-treated by using the silica particle dispersion (1) in a supercritical carbon dioxide atmosphere and siloxane compound as described below. In the surface treatment, an apparatus equipped with a carbon dioxide tank, a carbon dioxide pump, an entrainer pump, and a stirrer-mounted autoclave (capacity: 500 ml), and a pressure valve is used.

First, into the stirrer-mounted autoclave (capacity: 500 ml), 300 parts of the silica particle dispersion (1) is placed, and the stirrer is allowed to rotate at 100 rpm. Next, liquid carbon dioxide is injected into the autoclave, and the pressure is elevated by the carbon dioxide pump while elevating the temperature so that the inside of the autoclave is in a supercritical state at 150° C. and 15 MPa. While the pressure in the autoclave is maintained at 15 MPa by the pressure valve, supercritical carbon dioxide is distributed through the carbon dioxide pump to remove methanol and water from the silica particle dispersion (1) (solvent removing step) to thereby obtain silica particles (untreated silica particles).

Next, distribution of the supercritical carbon dioxide is stopped when the amount of the supercritical carbon dioxide distributed (cumulative amount: measured as the distribution amount of carbon dioxide in normal state) has reached 900 parts.

Subsequently, while the supercritical state of the carbon dioxide is maintained in the autoclave by maintaining the temperature at 150° C. by using a heater and the pressure at 15 MPa by using the carbon dioxide pump, a treatment agent solution obtained in advance by dissolving 0.3 parts of dimethyl silicone oil (DSO, trade name: “KF-96” produced by Shin-Etsu Chemical Co., Ltd.) having a viscosity of 10000 cSt serving as a siloxane compound in 20 parts of hexamethyldisilazane (HMDS produced by YUKI GOSEI KOGYO CO., LTD.) serving as a hydrophobizing agent relative to 100 parts of the silica particles (untreated silica particles) is injected into the autoclave through the entrainer pump. Subsequently, the reaction is carried out for 20 minutes at 180° C. under stirring. Next, the supercritical carbon dioxide is distributed again to remove the excess treatment agent solution. Then stirring is stopped, the pressure valve is opened to release the pressure in the autoclave to an atmospheric pressure, and the temperature is decreased to room temperature (25° C.)

Monodisperse silica particles (S1) are thus obtained by sequentially performing a solvent removal step and a surface treatment using HMDS and DSO.

The average primary particle diameter Rs of the obtained monodisperse silica particles (S1) is 45 nm, the particle size distribution index is 1.25 or less, the average circularity Ca is 0.90, and the specific gravity Da is 1.2.

Monodisperse Silica Particles

(S2) Monodisperse silica particles (S2) are obtained as with the monodisperse silica particles (S1) except that, in preparing the silica particle dispersion, the amount of methanol is changed from 320 parts to 340 parts, the amount of 10% ammonia water is changed from 72 parts to 76 parts, the amount of 8% ammonia water is changed from 9 parts to 15 parts, the dropping time is changed from 10 minutes to 13 minutes, and the dropping starting temperature is changed from 34° C. to 31° C.

The average primary particle diameter Rs of the obtained monodisperse silica particles (S2) is 70 nm, the particle size distribution index is 1.25 or less, the average circularity Ca is 0.94, and the specific gravity Da is 1.2.

Titanate Compound Particles

(T1) A metatitanate, which is a desulfurized and peptized titanium source, is collected in an amount of 0.7 mol as TiO2 and placed in a reactor. Next, 0.77 mol of an aqueous strontium chloride solution is placed in the reactor such that the SrO/TiO2 molar ratio is 1.1. Next, a solution obtained by dissolving lanthanum oxide in nitric acid is placed in the reactor such that the amount of lanthanum is 1.0 mol relative to 100 mol of strontium. The initial TiO2 concentration of the mixed solution of the three materials is adjusted to 0.75 mol/L. Next, the mixed solution is stirred and heated to 90° C. While the liquid temperature is maintained at 90° C. under stirring, 153 mL of a 10 N (mol/L) aqueous sodium hydroxide solution is added over a period of 2 hours, and stirring is further continued for 1 hour while maintaining the liquid temperature at 90° C. Next, the reaction solution is cooled to 40° C., hydrochloric acid is added until the pH reaches 5.5, and the resulting mixture is stirred for 1 hour. Next, decantation and re-dispersing in water are repeated to wash precipitates. To a slurry containing the washed precipitates, hydrochloric acid is added to adjust the pH to 6.5, and the solid component is separated by filtration and dried. To the dried solid component, an ethanol solution of i-butyltrimethoxysilane (i-BTMS) is added such that the amount of i-BTMS is 20 parts relative to 100 parts of the solid component, and then the resulting mixture is stirred for 1 hour. The solid component is separated by filtration and dried in air at 130° C. for 7 hours to obtain titanate compound particles (T1).

The average primary particle diameter Rt of the obtained titanate compound particles (T1) is 45 nm, the average circularity Cb is 0.86, and the specific gravity Db is 4.6.

Titanate Compound Particles (T2)

Titanate compound particles (T2) are obtained as with the titanate compound particles (T1) except that the time for which the aqueous sodium hydroxide solution is added is changed from 2 hours to 7 hours.

The average primary particle diameter Rt of the obtained titanate compound particles (T2) is 70 nm, the average circularity Cb is 0.86, and the specific gravity Db is 4.6.

Titanate Compound Particles (T3)

Titanate compound particles (T3) are obtained as with the titanate compound particles (T1) except that the time for which the aqueous sodium hydroxide solution is added is changed from 2 hours to 10 hours.

The average primary particle diameter Rt of the obtained titanate compound particles (T3) is 90 nm, the average circularity Cb is 0.90, and the specific gravity Db is 4.6.

### Example 1: Preparation of Toner 1

To 100 parts of the toner particles (A), 0.12 parts of the monodisperse silica particles (S1) and 1.4 parts of the titanate compound particles (T1) serving as an external additive are added, and the resulting mixture is mixed for 15 minutes in a 5 L Henschel mixer at a stirring peripheral speed of 30 m/sec to obtain a toner 1.

### Examples 2 to 9: Preparation of Toners 2 to 9

Toners 2 to 9 are obtained as in Example 1 except that the type and the amount of the monodisperse silica particles added and the type and the amount of the titanate compound particles added are changed as indicated in Table.

### Example 10: Preparation of Toner 10

A toner 10 is obtained as in Example 1 except that 100 parts of the toner particles (B) are used instead of 100 parts of the toner particles (A).

### Comparative Examples 1 to 3: Preparation of Toners C1 to C3

Toners C1 to C3 are obtained as in Example 1 except that the type and the amount of the monodisperse silica particles added and the type and the amount of the titanate compound particles added are changed as indicated in Table.

Measurement and Evaluation

### Properties of Toners

The ratio Rt/Rs of each of the obtained toners is indicated in Table.

Table also indicates the external additive coverage A % of the monodisperse silica particles and the external additive coverage B % of the titanate compound particles of the obtained toner, the value A/B, and the aggregated silica ratio (“aggregation ratio” in the table) determined by the aforementioned methods.

Preparation of Developer

Each of the obtained toners and a resin coating carrier described below are placed in a V blender at a toner-to-carrier ratio of 9.2:91.8 (mass ratio), and the resulting mixture is stirred for 20 minutes to obtain a developer.

Carrier
Mn—Mg—Sr ferrite particles (average particle diameter: 40 μm): 100 parts
Toluene: 14 parts
Methyl polymethacrylate: 2 parts
Carbon black (VXC72 produced by Cabot Corporation): 0.12 parts

The aforementioned material except for the ferrite particles, and glass beads (diameter: 1 mm, the amount thereof is the same as toluene) are mixed, and the resulting mixture is stirred for 30 minutes at a rotation speed of 1200 rpm using a sand mill produced by Kansai Paint Co., Ltd., to obtain a dispersion. This dispersion and the ferrite particles are placed in a vacuum deaeration kneader, and the resulting mixture is dried while stirring and reducing pressure to obtain a resin-coated carrier.

Evaluation of Fogging

The obtained developer is loaded into a developing device of a modified model of an image forming apparatus “DocuCentre-VI C7771 (produced by Fuji Xerox Co., Ltd.)” (modification involves turning off the environmental change concentration automated control sensor). This modified model of the image forming apparatus is used to evaluate fogging.

Specifically, an image having an image density of 1% is repeatedly formed on 10,000 sheets of A4 paper in a low-temperature, low-humidity environment (10° C., 15% RH environment) under low R/L conditions, i.e., under the conditions that the power supply is turned off and a warm-up operation is performed for 10 seconds during the interval of forming one image and next image, and fogging in the images on the last 30 sheets is evaluated. The fogging evaluation indicators are as follows, and the results are indicated in Table.

### Fogging Evaluation Indicator

G1: Fogging is observed in none of the thirty sheets.

G2: Slight fogging is observed in one sheet but the extent thereof is within the practically acceptable range.

G3: Slight fogging is observed in more than one sheets, but the extent thereof is within the practically acceptable range.

G4: Notable fogging is observed in more than one sheets, and the extent thereof is outside the practically acceptable range.

G5: Extensive fogging is observed in all of the thirty sheets.

TABLE

| | Toner | | | | | | Titanate compound | | | Silica | | | |
|---|---|---|---|---|---|---|---|---|---|---|---|---|---|
| | particles | External additive | | | | | | Particle | Amount | | Particle | Amount | |
| | Crystalline | | A | B | | Aggregation | | diameter | added | | diameter | added | Evaluation |
| | resin | Rt/Rs | (%) | (%) | A/B | ratio | Type | [nm] | [parts] | Type | [nm] | [parts] | Fogging |
| Example 1 | Yes | 1.00 | 5 | 15 | 0.33 | 60% | T1 | 45 | 1.4 | S1 | 45 | 0.12 | G1 |
| Example 2 | Yes | 1.00 | 15 | 15 | 1.00 | 50% | T1 | 45 | 1.4 | S1 | 45 | 0.36 | G2 |
| Example 3 | Yes | 1.00 | 30 | 15 | 2.00 | 25% | T1 | 45 | 1.4 | S1 | 45 | 0.73 | G3 |
| Example 4 | Yes | 1.00 | 5 | 5 | 1.00 | 40% | T1 | 45 | 0.5 | S1 | 45 | 0.12 | G2 |
| Example 5 | Yes | 1.00 | 30 | 30 | 1.00 | 50% | T1 | 45 | 2.8 | S1 | 45 | 0.73 | G2 |
| Example 6 | Yes | 1.00 | 5 | 50 | 0.10 | 80% | T1 | 45 | 4.7 | S1 | 45 | 0.12 | G3 |
| Example 7 | Yes | 2.25 | 5 | 15 | 0.33 | 70% | T1 | 45 | 1.4 | S2 | 20 | 0.05 | G2 |
| Example 8 | Yes | 1.56 | 5 | 15 | 0.33 | 70% | T2 | 70 | 2.2 | S1 | 45 | 0.12 | G2 |
| Example 9 | Yes | 3.50 | 5 | 15 | 0.33 | 80% | T2 | 70 | 2.2 | S2 | 20 | 0.05 | G3 |
| Example 10 | No | 1.00 | 5 | 15 | 0.33 | 60% | T1 | 45 | 1.4 | S1 | 45 | 0.12 | G3 |
| Comparative | Yes | 1.00 | 25 | 5 | 5.00 | 5% | T1 | 45 | 0.5 | S1 | 45 | 0.60 | G5 |
| Example 1 | | | | | | | | | | | | | |
| Comparative | Yes | 1.00 | 25 | 10 | 2.50 | 10% | T1 | 45 | 1.0 | S1 | 45 | 0.60 | G4 |
| Example 2 | | | | | | | | | | | | | |
| Comparative | Yes | 4.50 | 25 | 5 | 5.00 | 10% | T3 | 90 | 1.0 | S2 | 20 | 0.27 | G5 |
| Example 3 | | | | | | | | | | | | | |

The aforementioned results show that the toners of Examples suppress fogging when a low-image-density image is repeatedly formed in a low-temperature, low-humidity environment under the low R/L conditions.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A toner for developing an electrostatic charge image, the toner comprising:
toner particles having an average circularity Cc of 0.80 or more and less than 0.98; and
an external additive containing monodisperse silica particles and titanate compound particles,
wherein:
a ratio Rt/Rs of an average primary particle diameter Rt of the titanate compound particles to an average primary particle diameter Rs of the monodisperse silica particles is 0.50 or more and 3.50 or less, and
a ratio A/B of an external additive coverage A (%) of the monodisperse silica particles on surfaces of the toner particles to an external additive coverage B (%) of the titanate compound particles on the surfaces of the toner particles satisfies formula (1) below:
0<A/B≤2.00 formula (1):

2. A toner for developing an electrostatic charge image, the toner comprising:
toner particles having an average circularity Cc of 0.80 or more and less than 0.98; and
an external additive containing monodisperse silica particles and titanate compound particles,
wherein the monodisperse silica particles contained in aggregates that contain the titanate compound particles account for, in terms of the number of particles, 20 number % or more of the monodisperse silica particles that are present on surfaces of the toner particles.

3. The toner for developing an electrostatic charge image according to claim 1,
wherein:
the monodisperse silica particles have an average primary particle diameter Rs of 20 nm or more and 70 nm or less, and
the titanate compound particles have an average primary particle diameter Rt of 20 nm or more and 70 nm or less.

4. The toner for developing an electrostatic charge image according to claim 1,
wherein:
the external additive coverage A of the monodisperse silica particles is 5% or more and 50% or less, and
the external additive coverage B of the titanate compound particles is 5% or more and 50% or less.

5. The toner for developing an electrostatic charge image according to claim 1,
wherein:
the monodisperse silica particles have an average circularity Ca of more than 0.86 and less than 0.94, and
the titanate compound particles have an average circularity Cb of more than 0.78 and less than 0.94.

6. The toner for developing an electrostatic charge image according to claim 5, wherein the average circularity Ca of the monodisperse silica particles is larger than the average circularity Cb of the titanate compound particles.

7. The toner for developing an electrostatic charge image according to claim 1,
wherein:
the monodisperse silica particles have a specific gravity Da of 1.1 or more and 1.3 or less, and
the titanate compound particles have a specific gravity Db larger than the specific gravity Da of the monodisperse silica particles.

8. The toner for developing an electrostatic charge image according to claim 7, wherein the specific gravity Db of the titanate compound particles is 4.0 or more and 6.5 or less.

9. The toner for developing an electrostatic charge image according to claim 1, wherein the titanate compound particles are alkaline earth metal titanate particles.

10. The toner for developing an electrostatic charge image according to claim 1, wherein the titanate compound particles contain a dopant.

11. The toner for developing an electrostatic charge image according to claim 10, wherein the dopant is at least one selected from lanthanum and silica.

12. The toner for developing an electrostatic charge image according to claim 1, wherein the toner particles have a volume average particle diameter of 5 μm or more.

13. The toner for developing an electrostatic charge image according to claim 1, wherein the toner particles have a small diameter-side volume particle size distribution index of 1.25 or more.

14. The toner for developing an electrostatic charge image according to claim 1, wherein the toner particles contain a crystalline polyester resin.

15. The toner for developing an electrostatic charge image according to claim 14, wherein an exposure ratio of the crystalline polyester resin on the surfaces of the toner particles is 2% or more and 10% or less.

16. An electrostatic charge image developer comprising the toner for developing an electrostatic charge image according to claim 1.

17. A toner cartridge detachably attachable to an image forming apparatus, the toner cartridge comprising the toner for developing an electrostatic charge image according to claim 1.

18. A process cartridge detachably attachable to an image forming apparatus, the process cartridge comprising a developing unit that stores the electrostatic charge image developer according to claim 16 and develops an electrostatic charge image on a surface of an image bearing member into a toner image by using the electrostatic charge image developer.

19. An image forming apparatus comprising:
an image bearing member;
a charging unit that charges a surface of the image bearing member;
an electrostatic charge image forming unit that forms an electrostatic charge image on the charged surface of the image bearing member;
a developing unit that stores the electrostatic charge image developer according to claim 16 and develops an electrostatic charge image on a surface of an image bearing member into a toner image by using the electrostatic charge image developer;
a transfer unit that transfers the toner image on the surface of the image bearing member onto a surface of a recording medium; and
a fixing unit that fixes the transferred toner image on the surface of the recording medium.
